(19) United States
(12) Patent Application Publication
(10) Pub. No.: US 2002/0029350 A1
(43) Pub. Date: Mar. 7, 2002

(54) Web based human services conferencing network

(76) Inventors: Robin Ross Cooper, La Mesa, CA (US); Robert T. Kulakowski, Rancho Santa Fe, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/782,707

(22) Filed: Feb. 12, 2001

Related U.S. Application Data
(60) Provisional application No. 60/250,445, filed on Nov. 30, 2000.
(60) Provisional application No. 60/223,128, filed on Aug. 7, 2000.
(60) Provisional application No. 60/209,506, filed on Jun. 5, 2000.
(60) Provisional application No. 60/183,638, filed on Feb. 18, 2000.
(60) Provisional application No. 60/182,015, filed on Feb. 11, 2000.

(51) Int. Cl. H04L 9/00; G06F 17/60

(52) U.S. Cl. 713/200; 705/1

(57) ABSTRACT

A method and system for providing a secure communication network to facilitate consultations between a client and a counselor that limits legal liability to the participants comprising at least one web module, a certificate module, from which a digital certificate is issued to the client once said client contacts the at least one web module, a liability limitation module through which a liability limiting agreement is provided to the client via the at least one web module, a payment module, to which the client communicates a payment method via the at least one web module, a consultant database module, from which the client selects a consultant of choice via the at least one web module, and a consultation module, within which the consultant of choice and the client confer via the at least one web module in a secure environment is described.

### RELATED CASES

This application claims priority to U.S. Provisional Application No. 60/250,445, filed Nov. 30, 2000, U.S. Provisional Application No. 60/223,128, filed Aug. 7, 2000, U.S. Provisional Application No. 60/209,506, filed Jun. 5, 2000, U.S. Provisional Application No. 60/183,638, filed Feb. 18, 2000, and U.S. Provisional Application No. 60/182,015, filed Feb. 11, 2000, all of which are hereby incorporated by reference.

### BACKGROUND OF THE INVENTION

It is well known that the future of the Internet revolves around the huge applications such as extended e-mail services, voice-over-IP, video-on-demand, instant access to information, real-time stock and commodity trading, and other applications. One potentially huge application that has not arrived at this early stage of Internet deployment is Web Based Human Services or, Real-time Human Consulting Services over the Web.

### SUMMARY OF THE INVENTION

The invention disclosed herein relates to a method and system for providing a secure communication network to facilitate consultations between a client and a counselor that can limit legal liability to the participants comprising at least one web module, a certificate module, from which a digital certificate is issued to the client once said client contacts the at least one web module, a liability limitation module through which a liability limiting agreement is provided to the client via the at least one web module, a payment module, to which the client communicates a payment method via the at least one web module, a consultant database module, from which the client selects a consultant of choice via the at least one web module, and a consultation module, within which the consultant of choice and the client confer via the at least one web module in a secure environment.

### BRIEF DESCRIPTION OF THE DRAWINGS

FIG. 1 is a block diagram indicating the relationship of a client and a consultant to a VPN of the disclosed invention.

FIG. 2 illustrates a typical computer network configuration.

FIG. 3 is a block diagram of a system that permits clients and consultants to confer in a confidential electronic communication environment.

FIG. 4 is a graphic representation of a digital certificate.

FIG. 5 is a flow chart depicting a method by which a client and consultant may confer in a confidential electronic communication environment.

### DETAILED DESCRIPTION OF THE PREFERRED EMBODIMENT

The invention disclosed herein relates to a network of expert consultants that are connected through a virtual private network (VPN). A VPN is a communications environment within which one or more clients may communicate with one or more consultants to exchange information. Typically, users of the VPN are linked, directly or indirectly, to the VPN via the Internet. In a preferred embodiment, this communications link is encrypted or otherwise secured and protected from outside intrusion. The architecture of a suitable VPN will provide security, authentication, integrity, nonrepudiation, and indemnity for its users.

Definitions

The following discussion provides a number of useful definitions of terms used to describe the disclosed invention.

As used herein, the terms “communication network” and “Internet” refer to a network or combination of networks spanning any geographical area, such as a local area network, wide area network, regional network, national network, and/or global network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communication services (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

As used herein, a VPN is a secure and encrypted communications link between nodes on the Internet, a Wide Area Network (WAN), or an Intranet. These nodes can communicate with each other, however, it is virtually impossible for a hacker to either comprehend the meaning of the signals or send signals that are believed to be authentic. One secure communications technology that is designed to facilitate a VPN is Secure Sockets Layer (or SSL). Other secure communications technologies can be used as well. It is not a requirement that a VPN be a private network such as SITA, the international network for airline reservations.

As used herein, a VPN provider refers to software, hardware, or both that secure an audio/video conferencing session in such a way as to minimize the possibility that it can altered or inappropriately viewed or transmitted. A VPN can operate between a number of internet-enabled devices, for example, a VPN can run on two PCs that are connected together using well known security technologies. In another embodiment, a VPN can operate between a PC and a Web Site using security technologies. In yet another embodiment, a VPN can additionally operate between many PCs and/or many Web Sites. Hand-held devices, mobile phones, and web-enabled TV sets can be used as client devices instead of PCs as part of the VPN as well.

As used herein, the term “website” refers to one or more interrelated web page files and other files and programs on one or more web servers, the files and programs being accessible over a computer network, such as the Internet, by sending a hypertext transfer protocol (HTTP) request specifying a uniform resource locator (URL) that identifies the location of one of said web page files, wherein the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

In one embodiment, the website of the present invention includes a set of web pages, such as the above-mentioned home page. As used herein, a “web page” comprises that which is presented by a standard web browser in response to an http request specifying the URL by which the web page file is identified. A web page can include, for example, text, images, sound, video, and animation.

As used herein, a “customer” refers to a person that seeks professional advice from a VPN or VPN provider. The terms “customer,” “client,” “visitor,” and “user” are used interchangeably herein.

As used herein, a computer, may be any microprocessor or processor controlled device that permits access to the Internet, including terminal devices, such as personal computers, workstations, servers, clients, mini computers, main-frame computers, laptop computers, a network of individual computers, mobile computers, palm-top computers, hand-held computers, set top boxes for a television, other types of web-enabled televisions, interactive kiosks, personal digital assistants, interactive or web-enabled wireless communications devices, mobile web browsers, or a combination thereof. The computers may further possess one or more input devices such as a keyboard, mouse, touchpad, joystick, pen-input-pad, and the like. The computers may also possess an output device, such as a screen or other visual conveyance means and a speaker or other type of audio conveyance means.

These computers may be uni-processor or multi-processor machines. Additionally, these computers include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device such a network interface card, a modem, or other network connection device suitable for connecting to the communication network. Furthermore, the computers execute an appropriate operating system such as Linux, Unix, Microsoft® Windows® 95, Microsoft® Windows® 98, Microsoft® Windows® NT, Apple® MacOS®, or IBM® OS/2®. As is conventional, the appropriate operating system includes a communications protocol implementation which handles all incoming and outgoing message traffic passed over the Internet. In other embodiments, while the operating system may differ depending on the type of computer, the operating system will continue to provide the appropriate communications protocols necessary to establish communication links with the Internet.

The computers may advantageously contain program logic, or other substrate configuration representing data and instructions, which cause the computer to operate in a specific and predefined manner as described herein. In one embodiment, the program logic may advantageously be implemented as one or more object frameworks or modules. These modules may advantageously be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

Computers associated with the web site may be generally referred to as “host computers.” Computers associated with a customer visiting the web site may be referred to as “client computers,” “user computers” or “customer computers.”

The various components of the system may advantageously communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may advantageously be implemented to execute on one or more computers. In another embodiment, some of the components, modules, and databases may be implemented to execute on one or more computers external to the web site. In this instance, the web site includes program logic, which enables the web site to communicate with the externally implemented components, modules, and databases to perform the functions as disclosed herein.

Network Architecture of the Network

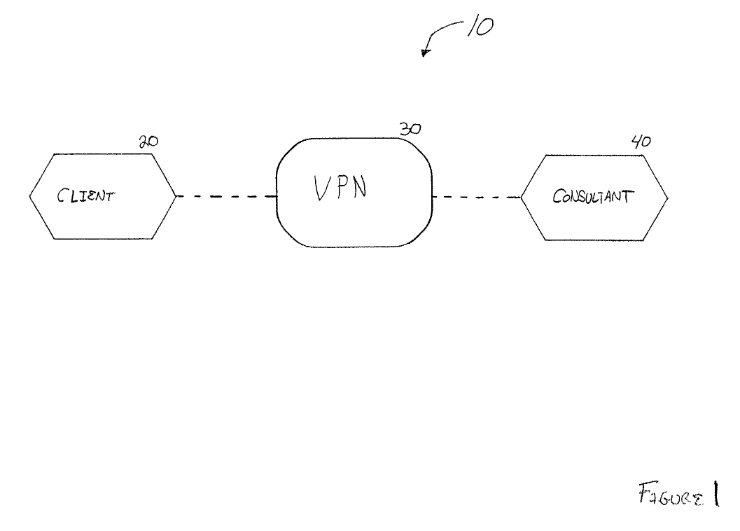

The systems and methods described herein can be implemented using a system architecture such as is depicted in FIG. 1. As depicted, a system 10 is shown linking a client 20 and a consultant 40 with a VPN 30.

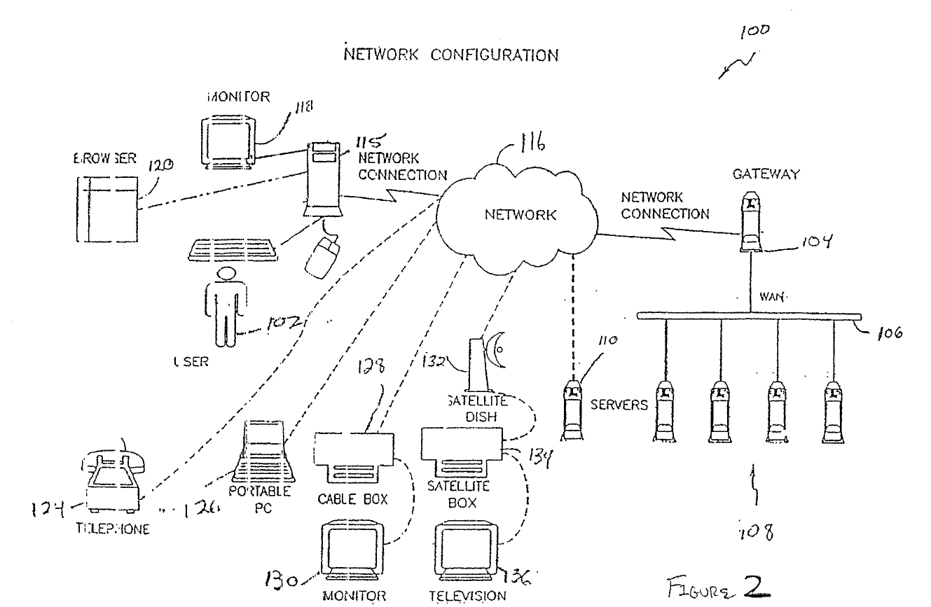

An exemplary network configuration 100 is depicted in FIG. 2. A user 102, which can be a consumer or a consultant, communicates with a computing environment, which may include multiple server computers 108 or single server computer 110 in a client/server relationship on a computer network 116. In a client/server environment, each of the server computers 108, 110 includes a server program that communicates with a client computer 115.

The server computers 108, 110, and the client computer 115 may each have any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. Furthermore, the server computers 108, 110 and the client computer 115 may be desktop, server, portable, hand-held, set-top, or any other desired type of configuration. Furthermore, the server computers 108, 110 and the client computer 115 each may be used in connection with various operating systems such as: UNIX, LINUX, Disk Operating System (DOS), VxWorks, PalmOS, OS/2, Windows 3.X, Windows 95, Windows 98, and Windows NT.

The server computers 108, 110, and the client computer 115 may each include a network terminal equipped with a video display, keyboard and pointing device. In one embodiment of network configuration 100, the client computer 115 includes a network browser 120 that is used to access the server computer 110. In one embodiment of the invention, the network browser 120 is INTERNET EXPLORER (Microsoft, Inc., Redmond, Wash.).

The user 102 at the computer 115 may utilize the browser 120 to remotely access the server program using a keyboard and/or pointing device and a visual display, such as a monitor 118. It is noted that although only one client computer 115 is shown in FIG. 2, the network configuration 100 can include a plurality of client computers.

The network 116 may include any type of electronically connected group of computers including, for instance, the following networks: a virtual private network, a public Internet, a private Internet, a secure Internet, a private network, a public network, a value-added network, an intranet, and the like. In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). The network 116 may connect to the client computer 115, for example, by use of a modem or by use of a network interface card that resides in the client computer 115.

In one embodiment, the server computers 108 are connected via a wide area network 106 to a network gateway 104, which provides access to the wide area network 106 via a high-speed, dedicated data circuit.

Devices other than the hardware configurations described above can also be used to communicate with the server computers 108, 110. For example, if the server computers 108, 110 are equipped with voice recognition or DTMF hardware, the user 102 can communicate with the server programs by use of a telephone 124.

Other connection devices for communicating with the server computers 108, 110 are also contemplated for use with the disclosed invention. For example, suitable communication devices include a portable personal computer 126 with a modem or wireless connection interface, a cable interface device 128 connected to a visual display 130, and a satellite dish 132 connected to a satellite receiver 134 and a television 136. For convenience of description, each of the above hardware configurations are included within the definition of the client computer 115.

Further, it is noted the server computers 108, 110 and the client computer 115, need not necessarily be located in the same room, building or complex. In fact, the server computers 108, 110 and the client computer 115 can each be geographically distinct from one another.

The VPN

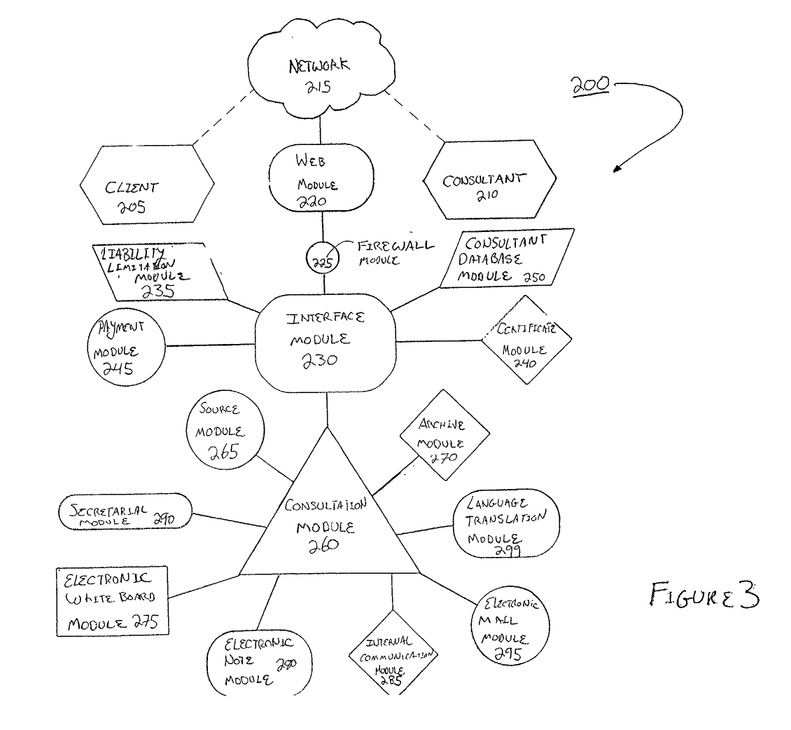

The VPN disclosed herein is composed of a number of modules through which users of the system can engage in the confidential exchange of information. A preferred configuration of functional modules is illustrated in FIG. 3. After the client has requested consulting services, the VPN system 200 will make certain decisions based on reducing the exposure to liability. These decisions can be made based upon information in the client's digital certificate; information in the consultant's digital certificate, and/or; responses to queries from the VPN to the client and/or consultant. These means for accomplishing these inquiries are discussed below.

In one embodiment of the invention, a client 205 will communicate with a consultant 210 via the Internet 215. Although a single consumer and consultant are depicted, the system can be configured to accommodate multiple consumers and multiple consultants, depending on the needs of the respective clients. In one aspect of the invention, the parties communicate by contacting a World Wide Web site produced by a web module 220. The web site hosted by the web module will typically contain a variety of reference materials regarding the consulting services facilitated by the service provider, who operates the system 200. In this embodiment, the service provider need not necessarily provide the consulting services of interest. Rather, the service provider can act solely as a clearinghouse within which various professional services are made available.

The VPN can exist within the system configuration 200 of FIG. 3. The hardware for the system 200 can be supplied by a variety of assemblies. One embodiment of the invention comprises a number of servers that provide the hardware to actualize the various modules discussed below. An exemplary list of servers includes a source server (for databases and executable program code), a firewall server (to keep mission critical information to be exposed to hackers), a web server (to provide a web site to the general public—typically outside the firewall), an archive server (to copy, encrypt, and archive the streaming media as well as the any other type of binary or text data), an e-mail server (to communicate with users as needed), certificate server (to generate encryption keys, digital certificates, and other secure processes), payment server (to receive payments from clients over the internet), transaction server (to log and process various necessary transactions), load balancing server (to distribute to computing resources in order to maintain the best possible system performance to the users on the network).

The system will also comprise additional hardware and software as necessary. For example, one or more line cards (circuit board) can be installed at the user's ISP to increase the speed with which video signals are transmitted within the system. Optional places for such a line card is at the client device or at one or more of the servers. These line cards will significantly improve throughput, as they will direct video streams to the video archive module with enormous speed and efficiency.

Examples of the types of information available on the web site include lists of the various types of consulting services available through the system 200, lists of consultants, and costs associated with obtaining consultation services. In a preferred embodiment, the web site will discuss the liability waiver that participants will sign in order to receive the consultation services of the system. This waiver and the other liability limiting features of the system are discussed more fully below.

Additional hardware and software to form system gateways, interfaces, protocols, and software tools that are required to connect to the Internet, wireless devices, databases, hardware platforms and other necessary services may be required. An example of such hardware and software is found in a system layer named TWISTER Brokat, Inc. (San Jose, Calif.). TWISTER can be used to supply the various components described above, however, other systems besides TWISTER can be used as well.

Once contacting the web site the parties will typically be passed through a firewall module 225 into an interface module 230. The firewall comprises standard software and hardware technology notoriously well known in the art. The firewall module provides the first of many security features designed to limit access to the consultation module 260 and the services provided therein. Additional security functions are accomplished by the interface module 230.

The Interface Module

The interface module 230 is a platform that performs one or more security functions. For example, the identity of potential system users is determined at the interface module by the certificate module 235. Details regarding the system's liability limitation agreement are provided by the liability limitation module 240. In one embodiment, consent to the liability limitation agreement is obtained and recorded by the liability limitation module. Additionally, it will be typical, although not required, for a payment module 245 to be a component of the interface module. The payment module obtains and controls means of payment for the consultation services obtained from the system 200. Also, a consultant database 250, which lists the consultants available from the system 200 and details about each consultant are stored, maintained, and furmished by the consultant database module 250. Each of these modules are discussed in more detail below.

The Certificate Module

In one embodiment of the invention, a certificate module exploits digital certificate technology to achieve the requisite level of security. An example of suitable digital certificate technology is defined by the X.509 protocol, which has been articulated by the Internet Engineering Task Force (IETF) and International Telecommunication Union (ITU) Standards Committees. Digital certificate technology has long been available for securing web sites, e-mail transmissions, file transfer protocol (FTP) transmissions, and other communications techniques over public networks. Four such companies that have deployed digital certificate technology are Verisign (Mountain View, Calif.), Baltimore eSecurity (formerly CyberTrust)(Needham, Mass.), and RSA (Bedford, Mass.). These companies have brought digital certificate technology into practice on the Internet.

The ITU and IETF standards committees have been defining procedures, methods, and protocols that will facilitate multi-point video conferencing over IP. Specifically, the H.245 definition is well suited to be the backbone technology behind the methods and processes described in the application. The H.245 document describes how signals are transferred, how security is achieved, and how multi-point video conferencing sessions will work in a highly efficient and capable manner. The H.245 documentation does not mention any specific applications and it does not solve the problem of potential liability. Therefore, the disclosure in this application is different and has a separate focus than does the H.245 documentation.

The H.245 document does explain how a multi-point video conferencing session can be delivered over the Internet without using a public network such as the Internet or a private network such as SITA (described above). It is anticipated that the technology disclosed in this application will operate over the Internet more than it will operate over a private network such as SITA.

In one embodiment of the invention, public/private key encryption technology is used as a basic building block for the consulting system. Public/Private key encryption technology allows for digital certificates to be created and thereby provides for secure the real-time transmission links. This encryption technology allows permits session encryption keys to be shared between all session participants and the video archiving service. This technology also allows for the encryption and archiving of the consulting session that occur on the VPN. Moreover, encrypted records are advantageous because the archived session can only be viewed by authorized parties.

Signing and Digital Certificates

Digital certificates are the electronic counterpart of an identification card, not unlike a driver's license or passport. Validity of a digital certificate is typically based on similar systems to those used to issue physical identification cards. Generally, one provides information about oneself to a trusted public body called a Certification Authority. The Certification Authority validates the information and then issues a digital certificate. The issued digital certificate typically contains information about who the certificate was issued to, as well as the certifying authority that issued it. Additionally, some certifying authorities may themselves be certified by a hierarchy of one or more certifying authorities, and this information may also form part of the certificate. When a digital certificate is used to sign documents and software, this identification information is stored with the signed item in a secure and verifiable form so that it can be displayed to a user to establish a trust relationship.

Digital certificates use a cryptographic technology called public-key cryptography to sign software publications and to verify the integrity of the certificate itself. Public key cryptography uses a matched pair of encryption and decryption keys called a public key and a private key. The public-key cryptography algorithms perform a one-way transformation of the data they are applied to, so that data encrypted with one key can only be decrypted by the other key. Additionally, each key uses a sufficiently large value to make it computationally infeasible to derive a private key from its corresponding public key. For this reason, a public key can be made widely available without posing a risk to security.

Although the preferred embodiment discloses that encryption keys will be generated by a software applet that is initially loaded into the user's computer, it is possible to generate keys for client and/or consultants from a Root CA, the video archive module, an independent entity that generates encryption keys for the VPN, or another key generation facility.

To further reduce the possibility that someone will derive a private key from its public key, the certifying authority timestamps the key pair so that they must be replaced periodically, and thus provides an additional mechanism to assure that a signature was applied before the certificate expired. Any signature applied during the active lifetime of the digital certificate may remain valid for an unlimited time (unless the signed item is tampered with or the signature is removed). Signatures applied after the digital certificate expires are typically invalid.

To understand how public-key cryptography works, it helps to first describe how it is used to encrypt e-mail messages. To do this, the sender obtains the recipient's public key from a directory service and uses it to encrypt the message before sending it. When the message is received, the recipient uses his or her private key to decrypt the message. As long as the private key is kept secure, no other user can decrypt the message, and the recipient is assured that the transmission hasn't been tampered with.

A similar system is used to digitally sign documents and software, but instead of encrypting the entire file, the file is first passed through a one-way hashing algorithm to produce what is called a message digest. The message digest is a unique value that can be thought of as a “digital fingerprint” of the file. MICROSOFT OFFICE (Microsoft, Redmond, Wash.) uses the MD5 hashing algorithm to produce a message digest. Producing a message digest increases the efficiency of the process of creating and later verifying the signature for larger documents and software files. The message digest is then encrypted using the signer's private key, to produce the digital signature that is attached to the file.

To verify the integrity of the file, the application opening the file first uses the same hashing function to produce a message digest of the file. It then decrypts the signature attached to the file by using the signer's public key to recover the message digest produced when the file was originally signed. The two message digests are compared, and, if any part of the file has been modified or corrupted, the digests will not match and the contents of the file can't be trusted. The verification process will typically fail regardless of how the file was modified—whether through corruption, a macro virus, or programmatic changes made by an add-in or other solution. The verification process will also typically fail if the file wasn't signed with a valid certificate; that is, if the certificate had expired, or had been forged, altered, or corrupted. If another user modifies the VBA project, the MICROSOFT OFFICE 2000 (Microsoft, Redmond, Wash.) application removes the current signature and prompts the user to re-sign the VBA project; if the user doesn't sign the VBA project or signs it with another certificate, the file may fail the verification process. This same digital-signing process can also used within the digital certificate itself to identify the certificate as being produced by the certifying authority and to ensure that the certificate has not been altered or forged.

For added security, a digital certificate has an expiration date that is enforced by the certification authority. Typically, a digital certificate expires one year from the time it was issued. The reason for doing this is to greatly reduce the possibility that a malicious individual could derive a signature's private key from its public key. Though deriving a private key from a public key is extremely unlikely because of the vast number of possible combinations that would need to be calculated for large key values, it's still not theoretically impossible. Additionally, adding an expiration date limits the lifetime of the certificate in the event that it is stolen. The certificate's expiration date ensures that any signature made after a certificate expires is invalid.

If the certification authority that issued the certificate provides a time-stamping service, a hash of the code to be signed is sent over an Internet or intranet connection to a time-stamping server maintained by the certification authority to be verified. If the code is being signed within the valid lifetime of the signature, a timestamp is added to the signature, and the signature will remain valid even after the certificate expires. If the certification authority that issues your digital certificate doesn't support time stamping, all signatures made with your certificate become invalid after the certificate expires.

Virtually all web browser programs such as NETSCAPE (Netscape Communications Corporation, Mountain View, Calif.) and INTERNET EXPLORER (Microsoft, Redmond, Wash.) have a mechanism to store and manipulate encryption keys and digital certificates. It is common to see an area reserved for the creation, deletion, storage, and usage of digital certificates under the menu item named “options” or “preferences” in such web browser programs.

Digital certificates presently available solve many problems for the provider of the VPN consulting services. For example, the use of digital certificates allows for immediate identification and authorization of access to the VPN by customer's and consultant's computers. Additionally, the use of digital certificates also allows for the encryption of consultation sessions to prevent intrusion by unauthorized third parties. These characteristics support the formation and function of the VPNs described herein.

Digital certificates used with the described methods can have additional characteristics that will promote the functionality of the described VPNs. For example, the digital certificates issued to the consultants typically will have additional fields that will provide important information about a particular consultant. These fields include areas describing a particular consultant's educational and professional background, work experience, and the legal capabilities of the consultant. The digital certificates issued to the customers can also have fields indicating that the customer understands and consents to various liability-limiting conditions imposed upon the customer as a condition for gaining access to the VPN consulting service. Additionally, the primary residence and the business address of the customer and other important information that is necessary to provide consulting services can be included in the digital certificate.

In one embodiment, the information described above is written as a part of the digital certificate and will be founds as simple text data stored in an appropriate field of the Certificate. One place that might be ideal for such information is the certificate practice statement (CPS) field of the digital certificate. Additionally, other text strings can be stored within the digital certificate as well. Some of these other text strings may simply capture information that is valuable to query while a video conferencing session is taking place. These text fields within the digital certificate can be optionally encrypted using virtually any encryption method including the methods described in this application.

For the client, the extra fields in the CPS may contain information such as residence, age, educational background, financial status, and a list of topics that may be discussed by consultants without the risk of legal recourse. Other information can be added in order to better understand the risk that the client is willing to bear as well as information that will help a consultant in fulfilling the client's needs. There are potentially innumerable “Extra Fields” for the VPN provider as well as the client depending upon the needs that may arise in the future.

For the consultant, the extra fields may also contain information such as business address, educational background, personal background, areas of expertise and experience, a list of topics that have been approved by the provider of the VPN, and anything else that might help better understand the capabilities of the consultant. As described above for the client, innumerable other fields may be added as well depending on the demands and needs for information and/or disclosure.

The CPS field of the digital certificate can hold pointers to other types of documents or databases. For an example, the client and VPN may have agreed to terms and conditions that are separate from the terms and conditions necessary to gain access to the VPN. An extra field in the CPS may contain pointers to such separate agreements.

The CPS field of the digital certificate may also contain a pointer to a field in a database that is accessible via the WEB. It is possible that the CPS field may contain a pointer to a database field that can be accessed using LDAP (Sun Microsystems) or ODBC (Microsoft) calls to access the information in the database(s). Once one or more databases and fields within databases can be accessed then it is possible to execute certain functions or system features based on the information found in the database(s).

In one embodiment of the invention, querying a database involves allowing a client to access to a highly responsive client support video conferencing center for a predetermined length of time. (This client bought a new computer and he/she has 1 month to use this highly responsive client support service.) Each time the client tries to log-on to this service, a query is made to a database that contains the remaining length of time the client has left. If the time has run out for the client, an appropriate message will appear and the client will not be allowed access to this client support center.

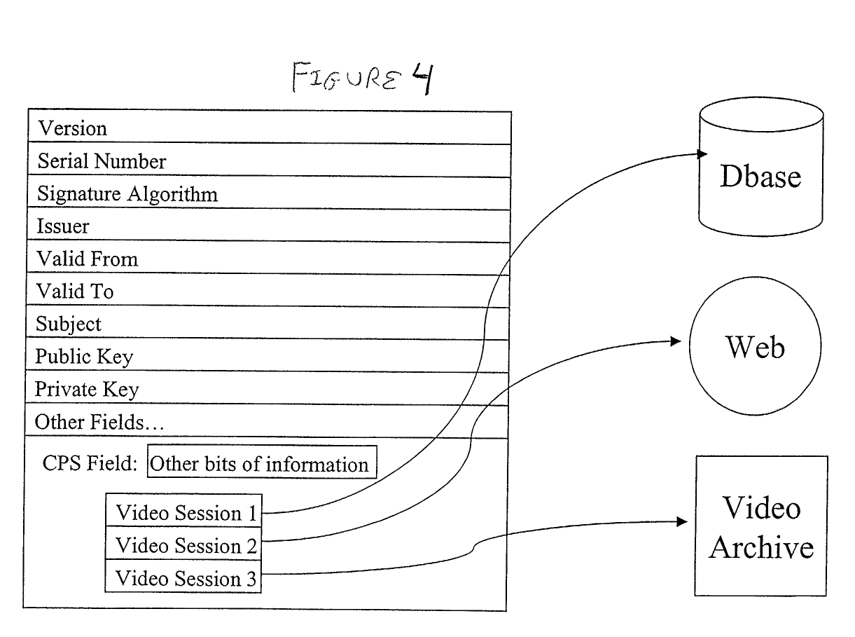

FIG. 4 represents the CPS field of a digital certificate and how it can contain pointers to databases, web sites (or URLs), and/or a video archive. The digital certificate can include the version of the software used to generate the digital certificate, the serial number of the certificate, the signature algorithm, the issuer of the certificate, the valid from and valid to dates, the subject, the public key, the private key, and other fields. FIG. 4 also shows the CPS field containing additional bits of information as described above.

In an alternative embodiment, the additional information discussed above can be stored in a variety of locations other than within the digital certificate itself. For example, this information can be stored numerous other places such as: on a hard disk drive, a floppy disk, or other external storage medium, as well as on a web site, or anywhere else where storage is accessible. Additionally, the client can store the digital certificates for both him/herself and for the consultant as well. Alternatively, the consultant can store the digital certificates for both him/herself and for the client as well. In another embodiment, the root CA can store all digital certificates. Or, the video archive (discussed below) can store all digital certificates. In still another embodiment, other external entities can store one or more of the digital certificates

The architecture of the VPN system described can permit the use digital certificates generated by any one of a number of digital certificate authorities. Many digital certificates may even be generated from countries other than the United States. Since it is anticipated that the VPN described above will be an international network, it is expected that clients as well as business from different parts of the world will prefer to purchase digital certificates from a certificate authority that might be physically located close to the client or business.

Generally, digital certificates will be generated using similar protocols. For example, because all digital certificates that are designed around the X.509 protocol maintain a similar data structure, it is not difficult to add the information that is necessary to limit liability as described above. Therefore, it is easy to use digital certificates that have been created by numerous other certificate-generating organizations. In a preferred embodiment, the VPN systems of the invention will generate and issue digital certificates designed around the X.509 protocol, although the use of other protocols is certainly contemplated.

Signing the Agreement

As used herein, the term “digitally signing” relates to the cryptographically standard process of using a private key to generate a message or message hash/digest that, when decrypted using a public key, validates that the message was generated using an individual's private key.

The user may use one of a number of state-of-the art methods for signing the agreement. Some examples of such methods include: using an electronic white board as described above to capture and transmit the client's signature; using an electronic pad that will capture and transmit a person's fingerprints; using another state-of-the-art means for capturing a signature as a graphic file and transmitting the graphic file using TCP/IP protocols (or other transmission protocols); Faxing a signature to the VPN provider; Mailing a signature to the VPN provider; Using an application software program that captures a signature (using mouse or pointer technology) and transmitting the signature to the VPN provider.

The term “Client ID” represents a positive digital identification of the user, computer, or player device owned by a person who downloads content, has access to content download systems, or can access the systems described herein. A positive digital identification can be one or a plurality of the following: an individual's digital certificate, a digital certificate or digital certificate serial number digitally signed using the user's private key, a transactional ID digitally signed using a user's private key that can be verified via the users public key, the serial numbers of computers and/or player devices owned or registered to a user, a message received into a system containing verified biometric data (finger print, face recognition, eye/retina recognition, voice recognition etc.) or any other means the provides a legally acceptable means to identify an individual.

Biometrics

It is possible to use biometrics devices within the VPN. It is possible to absolutely identify a person on the VPN using certain biometrics techniques that exist today. Examples of biometrics techniques include retinal scanner (eye scanner); finger print scanner; thumb print scanner; DNA scanner; and other type of biometrics scanning mechanism. In a preferred embodiment, the biometrics device are used along with the encryption keys and digital certificates. The scanned image created by the biometrics scanner will be saved along with the video stream at the video archive. The scanned image containing biometrics information will also be saved along with the Session and Public Encryption Keys as well.

Further Verification of Users on the VPN

Although there is certainly adequate verification of the users on a VPN, it is still possible to include more ways to verify the users. Some of these additional methods for verifying users on a VPN include use an on-line method to check name, SSN, address, and other information with one or more credit card companies of a user. For example, it is possible to require that a credit card or smart card number be entered into the VPN in order to allow certain people access to certain applications. As soon as this credit card information is entered into the VPN, verification processes can be initiated that will further verify the identity of the user. Additionally, the user's ISP service may also have information regarding the user such as name, address, e-mail address and other bits of information that can be used for verification purposes. Other similar processes can also be used to assist the VPN with verification of a user.

Viewing the Initial Agreement to Enter the VPN

As described above, the client/consultant can view the streaming video of the initial “Agreement” for the terms, conditions, policies, rules and regulations required by the VPN. This initial “Agreement” can be viewed at virtually any time. This can be done as long as the client/consultant has their own private key and the digital certificate containing a pointer to the physical location where the streaming video data can be located. In an alternate embodiment, it is possible to limit or eliminate the possibility that the client/consultant can view the initial “Agreement” video under any circumstances. It is also possible to require a formal request for the video “Agreement” to be viewed.

Network Without Digital Certificates

In some cases there may be little or no concern about liability. For an example, a large international corporation such as General Motors Corporation may wish to make consultants available who are extremely knowledgeable about automobiles. Such a corporation may choose to pay all expenses for such a network in order for the service to become “free” to the car-buying public. Such a corporation we will call a “sponsor” of consulting services. The consultants hired by the sponsor may only answer questions well within certain pre-defined boundaries. By only answering certain questions and by capturing each session in an archive, there may be adequate limits to the sponsor's exposure to liability. In these cases no digital certificates need to (or will be) issued. These sessions will become more like video-conferencing, teleconferencing, or chat room conversations. At the point the client begins to ask questions that are clearly outside the pre-defined boundaries, the sponsor may require that the client obtain a digital certificate as described above in order to receive additional counsel.

Coupons from a Sponsor

If a sponsor is going to assign personnel and expend the resources required to provide human consulting services on the web, these sponsors may wish to have some powerful and persuasive tools that will encourage clients to purchase some (or all) of the products produced by the sponsor. An example of one such tool is a highly valuable coupon. The sponsor can place a coupon on to a printer (or another storage mechanism) that is attached to the computer being used at the moment by the client. Such an automatic print or store function can be easily accomplished in web languages such as Java and VP Script.

The coupon that is printed may have some special qualities. These qualities include: such as: a banner with the client's name and address; a bar code that is intended to “catch” multiple people trying to use the same coupon; a special message or notice to the retail store that will redeem the coupon asking the person redeeming the coupon to call a special phone number or query a web site to verify that a coupon is valid and not already used; a special message or notice to the retail store to carefully check the proper identification of the client; the coupon can be printed; e-mailed; or otherwise transmitted directly to a retail establishment (possibly of the client's choice); and other such means to establish that a “special” coupon is not being misused or coupon “fraud” being conducted. In doing so, a significant incentive may be presented to a person that receives consulting services from a sponsor. This significant incentive may ultimately encourage a client to buy one or more of the sponsor's products.

The marketing strategy described above or other strategies may be exploited to provide excellent consultants who can adequately explain all of the advantages of a sponsor's products. A highly valuable coupon may then be issued to client in order to create an incentive for the client to purchase the sponsor's products.

Switching from a Unsecured Network to the VPN

Since it is possible that a counseling session may quickly turn from an innocent conversation about a product or service to a conversation that requires limits to liability, it will be important to “switch” from an unsecured environment to a secure environment. Switching to a secure environment will often involve the generate Encryption Key Pair (if key pair does not already exist), issuance of a digital certificate, initiation of an SSL Session, and commencement of the data stream comprising the consultation session.

One advantage of this network switching capability is the ability to adjust the network security environment as the conversation shifts from relatively low-risk issues and subjects to issues and subjects that have a at least a small amount of risk. For an example, an attorney may be speaking to a client about a fishing trip that was taken sometime in the past. All of a sudden, the client begins talking about a toxic waste spill he committed and asks for help. In such an example, all of the methods and processes for providing an indemnification network to this attorney should be deployed seamlessly, quickly, and thoroughly.

Liability Limitation Module

In addition to verifying the identity of the clients and consultants attempting to gain access to the VPN, it is important for the participants to acknowledge certain waivers on their ability to pursue legal action related to the advise received from a consultant on the VPN. Additionally, the rules and regulations of the VPN should be acknowledged and consent to follow them should be required before participation in the VPN will be permitted.

In one embodiment of the invention, customers who have been processed through the certificate module are passed to the liability limitation module for processing. Typically, the customers waive their right to bring legal action against the VPN provider to the fullest extent allowable by law. The relevant law will be determined either by the law governing the company supplying the VPN services, by the law of the state in which the consumer resides, or by the law of the state in which the consultant resides and practices. This waiver will allow the consultants to dispense their professional advice freed from the threat of litigation.

Additionally, a consultant or a client logging on to the VPN for the first time will be presented with the terms, conditions, rules, regulations, and policies of the VPN. The user is then given an opportunity to agree to the terms, conditions, rules, regulations, and policies of the VPN. In one embodiment of the invention, the user agrees to the agreement via audio/visual equipment, which then transmits the agreement of the user to the liability limitation module 235. The captured audio/video sequence of this “agreement” between the user and the VPN will prove that the user has previously agreed to the terms, conditions, rules, regulations, and policies of the VPN. This video agreement will be encrypted and stored in a Video Archive (accessible via the web) in such a way that the user can view this audio/video agreement at any time.

Signing a traditional agreement today is understood to mean that an original signature was written in the appropriate place (or places) within a legal document. Signing agreements electronically is something quite different. The reason for this is because the parties to an agreement may never be in the same physical location. The parties may specify the terms of an agreement and sign the agreement from two separate continents all within a very short period of time.

In the case of an agreement that has been entered into via a video conferencing session, the signing of the agreement may be accomplished through a number of means. In one embodiment, assent to the agreement is manifested when all parties to the agreement speak appropriate words during the video conferencing session that definitively prove the final terms and conditions of the agreement. In another embodiment, assent to following the rules and regulations of the VPN is manifested when the respective parties provide physical gestures such as the nodding of heads. One of many alternative physical gestures is the “thumbs up” signal, which can also be used to manifest assent to the rules and regulations of the VPN.

Once assent to follow the rules and regulations of the VPN has been manifested, a private key from each participant can be used to encrypt the electronic agreement. Placing a private key on the electronic document that records the assent to the agreement provides further evidence of the intent of the participants to agree with the terms and conditions of use of the VPN and to the authenticity of the electronic document demonstrating the assent of the parties.

There are numerous ways in which one or more Private Keys can be used to authenticate an on-line agreement. Private Keys from each of the parties can be affixed to the electronic record of the conferencing sessions. Alternatively, a small part of the conferencing session can be encrypted with the Private Key. A message digest (or small string of bytes) may also be encrypted and stored within the conferencing session data stream or outside the video conferencing data stream. The end result being a secure method for positively authenticating users by using the Public Keys that have been made available to the VPN.

In another embodiment, a session key can be used to encrypt the video agreement. In this embodiment, a session key is created using the private and/or public encryption keys of each participant to the electronic conferencing session. A session key can be helpful to easily and efficiently attest to the authenticity of a conferencing session record in which a number of parties has participated.

In addition to affixing encryption keys to the agreement, other information from a potential user of a VPN is required. For example, although both the consultants and the clients will establish a business address, a residence address, or both, the actual physical location during a session is unimportant. For example, a session participant may be on an airplane or at a tropical location. As long as all participants have the appropriate hardware, software, and authentication means to conduct a secure video conferencing session, then the session will be conducted as if all parties were at home or at the office.

As a general matter, customers will often agree in advance to either follow the advice given by the consultant or decline the advice following the advice using his or her best judgment without resorting to legal action if the advice yields results that are unsatisfactory to the customer.

Consent to the liability waiver agreement will typically be noted on the digital certificate, often in the CPS field. The CPS field of a digital certificate will typically contain a pointer or link to a web site containing the agreement written (see below) or electronic, between the parties to the agreement. Such a link makes the liability waiver agreement easily available for subsequent examination. Another method for making the agreement readily available is to have the CPS field of the digital certificate point to a database entry that will then again point to the archived agreement. This database may reside within the liability limitation module, on the certificate module, or on some other server that is accessible via the Internet. This server may be queried using various database access means such as SQL, LDAP, ODBC, or other such database protocols. By accessing such a database it is possible to determine where the archived agreement is stored and how best to access it. Access to the agreements will typically be encrypted in such a way that only the appropriate people can retrieve these documents for examination.

Agreement Between User and VPN May Be in Writing

Perhaps the easiest way to enter into an agreement to use the system described herein is to agree to the liability waiver agreement using the streaming audio/video capture devices contemplated for use with the described method. Nevertheless, it is also possible to enter an agreement using a traditional written legal document. If the VPN uses such a written legal document, then typically, a written copy of the liability waiver agreement is generated and must be signed by the appropriate parties. The signed document is then provided to the service for archival purposes to record the assent of the participants to the rules, regulations, and liability waiving conditions of the use agreement. The signed document may be digitized for future use. The digital certificate generated for the users may have electronic access to an electronic copy of the signed document. Additionally, consultants wishing to review the signed agreement document may access it through the liability limitation module.

Protection for Non-Human Experts

As video conferencing technologies become more popular, client service and support organizations will begin to deploy non-human (or artificial) characters (agents) that appear to be human for purposes of explaining solutions to common problems. These “Cyber Characters” will be programmed to both understand questions that are being asked and reply with the appropriate solution. The main reason for deploying “Cyber Characters” will be to save money by programming artificially intelligent visual images to accept questions and provide the appropriate answers without the need to pay wages or to provide benefits.

These “Cyber Characters” will need the same legal protection as human consultants. Using the methods and processes as defined in this application it is possible to guard the company providing the “Cyber Character(s)” from unwarranted legal activities.

In order for the methods and processes defined in this application to work, the Video Archive module will capture the entire video conferencing session just as if the “Cyber Character” was human. The “Cyber Character” will capture speech or text from the client and perform the appropriate parsing functions in order to understand the question being posed by the client. The “Cyber Character” will then evaluate the message from the client and reply with an artificially intelligent response. This entire session will then be captured by the Video Archive module and encrypted using the appropriate encryption methods, as described herein. If the company providing the “Cyber Character(s)” should ever need the evidence that the artificially intelligent responses were appropriate, the streaming video captured from the video conferencing session will then be available to such a company.

The Payment Module

In one embodiment, following verification of the user's identity and waiver of various legal rights, consumers of VPN services will be passed to the payment module to establish a payment method. Payment by the customer to the provider of the VPN can be accomplished using a number of methods well known in the art. Examples of such methods include payment by credit card, debit card, internet money, check, monthly subscriptions, valuable coupons issued by advertisers, and sponsorships paid for by advertisers, or other legitimate payment sources.

In one embodiment, the entire consultation session is timed and logged by the Payment module 245. Charges to the client and payments to the consultants will be calculated after each session. Routine bookkeeping functions can be maintained by all parties so the client knows that amount he/she is paying, the consulting knows the amount he/she is getting, and the VPN Provider knows the amount of profit that will be kept in order to run the VPN and return a profit to its investors. Sponsors or providers of valuable coupons for such a network can also be made aware of the amounts they owe and the services that have been rendered to date.

The Consultant Database Module

Once the consumer has been processed in the payment module, he is passed into the consultant database module 250 to seek a consultant of choice. The VPN described herein provides a network of expert consultants, connected and available through the VPN. The architecture of the VPN is designed to provide maximum security, authentication, integrity, non-repudiation, and indemnity for its users, both consumer and consultants.

The consultant database module 250 can perform a number of tasks relating to the consultants who use the VPN. In one embodiment, the consultant database will maintain a list of consultants who offer their services over a VPN as described herein. This module will offer a number of functions including, listing those consultants who have agreed to participate in the service, listing professional details relevant to each consultant, such as their education, their experience, and their availability for consultations.

The consultant database module 250 can also function as the means by which potential clients are matched with potential consultants. In a preferred embodiment, the consultant database module will attempt, unless otherwise requested, to match the client with a consultant that is in a close physical proximity. For example, in this embodiment, it is assumed that it would be better for a California resident to speak with a California attorney than an attorney from Florida. Consultants may make adjustments to their presentation and the valuable advice they provide once the location information of the client is known. This emphasis on the physical location, residence, and work address of the client may greatly reduce potential liability to the consultant and the VPN by routing the clients to the proper consultant based on location information.

It may be desirable for the consultant database module 250 to place restrictions on the lists of available consultants due to the nature of their consulting practice and the content that is associated with the practice. For example, consultant database module could acknowledge limitations placed on the access of a subscriber-minor to the consultants of the system that offered sexual therapy services.

The VPN may also use other means to block certain consulting activities and/or content. On such method is can be implemented using a variety of software programs. One such software program is NETNANNY (Toronto, Ontario, Canada). This software package helps parents block out unwanted content from a specific computing device. The VPN may use a similar technology to block inappropriate content from being accessible to one or more members of a family. Of course, all sorts of information can be protected from free disclosure on the service.

The actual means for placing restrictions on certain types of content is to assign each content area with a unique code. Such a code can be assigned either characters or digits that are meaningful. An example is such a code is “L2DEP999”. Each character of the code may have a particular meaning. In the example above, the “L” relates to the content, in this case “legal profession;” the “2” relates to the level of security, in this case the 2 would be the second highest level of security; The “DEP” relates to the nature of the service, in this case a deposition; finally, the “999” relates to a particular department conducting the deposition. If the code string indicates the nature of the video conferencing content is inappropriate for the home, office, or other such location, then no such content will be viewed, made available, previewed, or otherwise displayed in any fashion.

Numerous other access limitations can be performed by the consultant database module 250 to reduce risk to the consultant and the VPN before a client is connected with the consultant. These liability checks may be specific to each discipline. For an example, the VPN may wish to check the client's financial status before connecting him/her to a commodities day-trading consultant. A vitamin expert may wish to determine if the client has any allergies. A sales person may wish to check the import/export (or other) laws of a certain foreign country before connecting to a potential client or client in a foreign country.

A consultant providing services to the VPN will have a variety of means with which to make his or her services available to consumers on the VPN. In one embodiment, a consultant can set a “switch” (implemented in software, hardware, or a combination of both) on the VPN that indicates the consultants availability to provide consulting services. When the consultant sets the switch to the “Available” setting, the consultant may begin receiving communications from consumers that wish to receive counsel from the consultant.

The consultant may also set the switch to indicate a number of other possible states regarding the possibility of being retained. For example, an attorney who provides services through the VPN can set the switch to an “Unavailable” setting, under which the consultant will not receive requests for consulting services over the VPN. Another alternative provides for a message system with which a consultant can receive messages from potential clients when the consultant is not available.

If the consultant sets the switch to “Available”, a customer may be routed through the VPN to the consultant in an on-line, real-time fashion for counseling. Once the customer and the consultant have connected through the VPN, the consulting session will begin. The session takes place using state-of-the-art secure video conferencing technologies in an effort to make it appear as if both parties are in the same room speaking to one another.

A specific consultant that a client insists upon using may not be available at the exact time that he/she is needed. In this case the consultant may use an electronic scheduling mechanism that will perform the following tasks: show the client the various time slots that are currently available, allow the client to select an available time slot, inform the consultant that the client has selected a specific time slot, make the time slot that was selected unavailable to future clients.

It is also possible for the consultant to schedule a session (or continue a session) at a later date and/or time. The consultant can verbally agree with the client to a session scheduled in the future, or, the consultant can use the electronic scheduling mechanism described above which will allow the client to select the desired date and/or time of the next session. A third party individual such as a secretary or an assistant can schedule appointments for a consultant or expert.

The consultant can access the VPN from virtually any physical. After connecting to the Internet, the consultant will execute an application program that will contain certain communication tools (software, hardware, or both) along with an “Available-Unavailable” switch. The tools include scheduling routines, a list of past clients, and a list of tasks to be performed for various clients and other valuable and/or important routines. The switch when set to “Available” will allow a request from a client to go to an authorized consultant as routed by the provider of the VPN. The switch when set to “Unavailable” will not schedule clients for that particular consultant. The client may leave a message for the consultant and return to searching for an available consultant.

The consultant database module 250 may also regulate and promulgate consultant advertisements on the VPN. In one embodiment, the consultants may pay a fee or enter into some other arrangement with the VPN provider that will allow them to advertise their capabilities, services, pricing, special promotions, and/or other unique features. Such advertisements can be found in many forms. For example, advertisements may be in the form of cookies (used by web browsers software programs), web pages with detailed explanations, graphics and/or icons, sound files, streaming video images, multimedia presentations, animations, and other such advertising methods.

If a client has multiple consultants to choose from, it is possible that the client may wish to learn more about certain consultants before making the final selection. By exposing the client to advertising information, it is possible to increase the business for the consultant. When advertising is permitted on the service, the consultant will typically have access to numerous methods and opportunities to advertise on the network.

The system described herein also contemplates the use of non-human consultants as a source of advice and guidance to clients of the service. In one embodiment, artificially intelligent devices, comprising hardware, software, or both, can be made available through the system and methods described herein. Artificially intelligent agents are to be subjected to the similar standards of behavior and professional competence as human consultants.

Consultation Module

Once the liability, contractual, and book keeping functions of the system 200 have been satisfied, the client is passed from the interface module 230 to the consultation module 260. Consultants and clients may be connected for a consultation session using a number of means well known in the art.

Typically, a consultant will confer with the consumer using any one of a number of standard communication devices. Examples of such devices include digital streaming video cameras and microphones suitable for transmitting images and sounds between the participants, mechanisms to access the web in order to display web-based functions, materials and/or presentations, two-way electronic whiteboard that the consultant and the customer can use simultaneously in order to convey thoughts, concepts, or ideas, databases of reading materials that can be accessed by participants, and other instructional tools and materials that may help a consultant perform their job. Additionally, the consultation module may contain software programs that can be transmitted and executed on the customer's workstation. For example, these programs can be used as instructional aids or teaching tools.

Chat Room Consulting Sessions

Although the invention disclosed is directed toward a base of customers who are equipped with high-speed internet connections, web cameras, and microphones, potential customers having only a dial-up connection and lacking a web camera and microphone can also exploit the teachings proposed herein. For example, dial-up consumers may communicate with one or more consultants using well-known “chat room” technologies.

The Consulting Session

After the client has requested consulting services selection and the VPN has screened all available consultants and decided compiled a list of potential consultants for this particular client, the client selects the consultant or consultants of choice. These consultants are typically then notified by in one of the following ways: telephone call, pager message, message on the computer screen, caller-ID mechanism tied to a phone call, or any other means of contacting a person with a short message.

As soon as the consultant is notified, the consultant can move to the computer and make sure the communication equipment is configured properly. The consultant then activates hardware, software, or both to contact the VPN. As soon as the consultant is logged on, the consultant and the client can begin to communicate. In a preferred embodiment, both the consultant and the client are able to see each other with the digital cameras and likewise hear each other with digital microphones. Although, in some cases “seeing and hearing” technologies may not be possible (i.e. mobile phones or hand-held devices.) The client can then securely ask questions and receive counsel from the consultant as if the two people were in the same room.

The client can always request a specific consultant. This may be accomplished by saving the name or identification number of the consultant and referring to the client's name or identification number when making a request for a consultant in the future. If that particular consultant in unavailable an appropriate message will appear on the client's screen.

The consultant and the client can schedule a time to meet again in the future using an application software program provided by the VPN. The time-slot will then be noted and all necessary steps will be taken to make the connection between the client and the consultant at the appropriately scheduled time.

In order to further limit the exposure to liability, it may be understood and previously agreed by all parties that the VPN may choose to “Listen in” for the purposes of checking the quality and effectiveness of the advice given by the consultants. The VPN provider may wish to “observe” a particular consultant for virtually any reason relating to potential liability claims.

It is understood that there may not be a limit on liability if negligence, harm, bad service, malice, or fraud is involved. This is why the VPN provider must carefully “screen” each consultant and the VPN provider may additionally “listen in” as well. This monitoring function is similar to the current day AMERICA ON LINE Corp. (AOL) (AOL Time Warmer, WA). The chat rooms on AOL being observed by AOL chat room monitors. The VPN may decide to disconnect the consultant or revoke the consultant's privileges on the VPN at any time.

It may also be the requirement of a specific application that the “Listen In” or audio/video signal screening process become automatically activated as the application is initiated and stay active throughout the duration of the session. For an example, a consultant or expert may be performing a “mock” session (or a dress rehearsal) and the “Listen In” process is activated in order to allow training personnel and other types of instructors or teachers to monitor the “mock” session.

It is possible that one consultant may allow multiple clients to join in a video conferencing session or chat room session at the same time. It is also possible for one client to request that several consultants join in a video conferencing session or a chat room session at the same time. Furthermore, multiple clients and consultants can all join in a video conferencing session or a chat room session at the same time. Such conferencing sessions are referred to as Multi-Point conferencing sessions. Multi-point conferencing is well defined in the ITU and IETF standards H.323, H.245, and T.120. The methods and procedures defined in this application leverage the protocols and capabilities of these international open standards.

Source Module

The consultation module 260 possesses a number of functionalities with which consultation sessions are performed. Typically, a source module 265 is present to supply the necessary hardware, software, or both, to permit smooth functioning of the consultation session.

Archive Module

The consultation module 260 can also comprise an archiving capability supplied by an archive module 270. The consultation module can record communications that occur during a consulting session for later review. Providing the option of archiving a consultation session may be enormously helpful in deterring a consumer from initiating unwarranted legal actions. Archival information can be stored on the VPN using well known storage modalities.

Features of the Archive Module

The archive module 270 may have a number features. Examples of these features include a TCP/IP connection to the internet; video capture capability; audio capture capability; large disk storage capabilities; encryption keys; digital certificates; root CA Certificate; Windows NT, Linux, Unix, or similar network operating system; customized applications program; external communications bus for controlling external devices suchas additional storage devices, monitoring equipment, printers, modems, or other such devices that can be plugged into a communications bus.

The archive module 270 can be a archive server, which in turn can be a server system that communicates with the Internet via a LAN connection through a router and then through either to an ISP or directly to the backbone of the Internet. The LAN connection can be achieved by using a communications card such as an Ethernet card, or other such communications card. The archive server can have other communications cards that increase the audio/video capture capability. The archive server can have a display monitor, a fax/data modem for debugging and system maintenance functions. The archive server can also be equipped with a sophisticated communications bus such as SCSI or FIREWIRE that can connect to multiple internal or external devices. Among the devices to be connected to such a communications bus can be internal and external data storage devices, CD ROM read/write machines, DVD read/write machines, other logical and mechanical devices that will allow the Video Archive Sever to perform its functions.

The archive server can have a sophisticated operating system such as Windows NT, Linux, Sun Solaris, or other such operating system. The Archive Server can have LDAP and ODBC capabilities in order to read and write data to a database. The Archive Server will also be installed with a customized software applications program that can: Determine the preference settings for the session; appropriately adjust system according to preference settings; perform security functions (trusted authority “CA” functions); encrypt audio/video data; store encrypted audio/video data; retrieve encrypted audio/video data; post status information; maintain an event “log” file; read and write status information; act as host or Multi-point Control Unit (MCU) for the session; and other fimctions as required.

As the network described in the application becomes large, it is likely that this archive module will increase in size and capability significantly. It is possible that a plurality of archive servers may exist throughout the world and that each archive server may run a parallel operation in the case of a power outage or system failure to provide services within the archive module.

Storage

Archiving large numbers of video conferencing sessions may require a substantial storage capacity. In order to help reduce the storage requirements to a manageable level, many storage techniques may be used to manage the archives. Generally, state-of-the-art storage protocols will be used to maintain the VPN's archives. For example, various compression protocols will be exploited to minimize the amount of space taken by each record. Similarly, the frames of video that are stored may be much smaller than the frame that is displayed during the video conferencing session. These smaller frames may only contain the most important images during the session. Also, the archives may be transferred to a storage medium to be stored offline”. Archives transferred for off-line storage may be shipped to the consultant for archiving. The consultant may be contractually required to keep the archives.

The VPN may be operated to delete archival information that has not been used for a predetermined period of time. Importantly, once the statute of limitations to file a legal action arising from or related to a particular VPN consultation is reached, the archives related to that session may then be discarded. The governing law of the VPN, the consultant and the consumer are all analyzed to determine the relevant statute of limitation period.

Possible Hardware Platforms for the Video Archive

The archive module 270 will require sufficient storage space to store the communication records of the consulting sessions that occur in the consultation module 260. In one embodiment, all conferencing sessions are ultimately copied to DVD or similar disk technologies and deleted from the video archive server. If a certain session is needed for viewing, it will be restored from the DVD or similar disk technology that is carefully filed in a library or otherwise delivered to the proper authority.

One example of a suitable storage device in addition to archival disk copies is the Mega Drive EV-5000 Fibre Channel Network RAID System developed by DataDirect Networks, Inc. (Los Angeles, Calif.). This device has, using 3TB, sufficient storage to hold conference sessions for a reasonable period of time. In one embodiment, several of these machines used to provide sufficient storage space at any one time.

Copying Streaming Video to the Archive Module

The preferred embodiment for copying the streaming video to the archive module 270 is to use a filter on the H.323 and sub protocol layer and encrypt and transfer this encrypted video information to the video server, however, there are many other ways to copy the streaming video information. For example, the H.245 layer and other protocol and/or sub-protocol layers are suitable for use with the described invention.

Archive Module Acting as a Passive Participant of a Session

The archive module 270 that receives the streaming video from each participant of a conferencing session can be considered a passive participant of the session. The archive module receives data feeds. The archive module as a passive participant of a conferencing session can perform many important functions. For example, the archive module can provide post status information regarding the session. Status information may include (but is not limited to): start time of the session; duration of the session (constantly updating); participants of the session; whether participants are on-line or off-line; status of participants using electronic white-boards or other such devices; and other status information.

The archive module can also provide post progress information to a log file. Progress information may include start time of the session; date; participants of the session; last session date/time; preference settings (as described above); and other information appropriate to a log file.

Additional information that can be provided by the archive module 270 includes: encrypting streaming data; storing encrypted or unencrypted data; posting location of the stored video on a URL (or database) for later retrieval; transcription of the audio (speech) information; copying stored streaming video information to CD ROM or DVD; the capability to issue a root certificate authority (CA) certificate; the capability to issue a client certificate (digital certificate); the capability to verify client certificates; and the capability to initiate an SSL session; and other functions.

Triggering of the Video Archive

When a client and a consultant begin a conferencing session, a message will be sent to the archive module instructing the server to begin its operation. When the last participant of the session terminates the connection to the conferencing session, another message will be sent to the archive module indicating that the session is now complete and the video should be handled as per the preference settings that were pre-defined before the session. Messages can be specially encoded character strings that can be easily detected and parsed. Once such a message is parsed, the operation it requests will be initiated. Other such messaging techniques can be used as well.

The archive module can optionally run within a non-TCP/IP Environment as well. It is possible that a certain conferencing application may be operating on a network with protocols that are different from TCP/IP. The archive module can run on other network protocols, however, the functions and capabilities will remain the same.

For most applications the streaming data will be stored as described above and a pointer will be created that will allow the audio/video data to be located, retrieved, decrypted, and then played. Various methods can be used to create and maintain the necessary pointers. For example, a digital certificate saved in a browser's database can be read, updated with a new pointer, and then written back to the browser's database. A virtual number of pointers can, therefore, exist within a single digital certificate. Alternatively, a digital certificate can be created that contains a “hard coded” pointer that points to either a database location on the Internet, a URL on the Internet, or an encrypted file that contains another pointer to the actual audio/video data stream or document. This database location, URL, or file may contain a virtually unlimited number of pointers. Additionally, a log file can be created that will contain a virtually unlimited number of pointers. The pointer within this log file can point to database locations accessible on the Internet or URLs. If such a log file is implemented, it will then need to be “signed” by encrypting this log file using either the user's private key, the user's public key, or the session key. It is possible that the agreement that was originally created between the user and the network can have a pointer within the digital certificate and all subsequent pointers that are created either reside in a database, a URL, a data file, or a log file.

The VPN provider can store all pointers to video files (and document files) from a database system that is made available via the web. When the user logs on to the VPN and provides a user name and password, then the user can view a list of videos and documents and then select the video or document file he/she wishes to view. Although there are many different ways to archive and document files, point to these files, and make these files available to the client for retrieval, the client will most likely need the correct public or private keys in order to play or view these files.

Conferencing Log Files

Log files may be used extensively throughout the VPN. Each time an event takes place such as the generation of a session key or the initiation of a conferencing session, a log file may be created. Log files will typically be stored on a client's or consultant's PC or similar device, on a Root CA's system, within the video archive module, on other logical and physical locations, or combinations of locations.

Frequently, log files contain a message indicating each significant event, the date and time of the log file's creation, the encryption keys used, and other information that may be useful to the participants or for archival purposes.

Users May Decide to Archive/Not Archive

It is possible for such a network that the users themselves may have the ability to either archive or not the streaming data generated during a consultation session. The preferred embodiment for such a capability is the expert or consultant may decide to either not archive any portion of the session, or abort the archiving process because of potential liability problems. For example, a doctor may wish to refer a patient to another medical facility or hospital because he/she believes the patient may receive better care. In such a case, the doctor may abort the video archiving process.

The client can also either decide not to archive the video or abort the video archiving process as well. For example, the client may wish to remain anonymous while participating in a video conferencing opinion survey. In a multi-point video conference, any or all participants may have the ability to either not archive the video or abort the video archiving process. Users may not be able to abort the archiving process if the video is required to reduce liability as defined above. One criteria that will be used to allow a participant to abort the archiving process is the level of liability that exists due to the nature of the video conferencing session.

Streaming Data Saved on a Key or Wand

The streaming data from a conferencing session may be saved on to a small object such as a key or a wand. Such an object can be placed on a key ring and easily carried by a person to virtually any location on earth. Such a key or wand can then be used as a means to gain access to a secure physical location such as a secure office complex or a bank vault. This object can then be inserted into a scanning device and the streaming data can be viewed by either a human or a computer that will either allow or decline access to the secure facility.

The function of saving streamed video to such an object can be carried out by the Video Archive Authority and mailed to the user, or the user may be able to transfer an archived video clip to such an object using an object read/write device. Additional security means may be deployed such as CRC checks, hash checks, and encryption means that will verify that a user did not inappropriately create such an object.

Viewing Conferencing Sessions

Although the preferred embodiment for requesting the streaming data from an actual conferencing session requires a formal authorized demand for the data, it is also possible to allow access to the data in a number of ways. For example, a client or consultant can access a stored session at any time using encryption keys and the physical location of the video data contained within the CPS field of the digital certificate. Alternatively, the system can be configured to permit only the client or the consultant to access the stored information. One method of configuring the system to permit party specific access involves linking access to a client or consultant's encryption keys and the physical location of the video data contained within the CPS field of the digital certificate. In another embodiment, a root CA can access video at any time using encryption keys and the physical location of the video data contained within the CPS field of the digital certificate or another database.

Accessing archived material can require relevant information used to catalog each consultation session. This information includes but is not limited to the date and time of the video conferencing session, the encryption keys of the participants, a message requesting the release of the video that has been encrypted (signed) using one or more of the participant's private keys, and other information.

Message Digest

A message digest is a unique code (character or binary string) that is generated by using a private encryption key to encrypt portions or all of a decrypted file. A message digest is used when a document, image, or data file is published in a decrypted manner for virtually anyone to use. It is the message digest or the unique code that can be re-created by using the public encryption key and the same original document. If the message digest matches, then a user will know for sure that the original data has not been tempered with. If the message digest does not match, then it is an indication that the original data has been altered. For invention described herein, a message digest can be transmitted with any data file that is published in a decrypted manner. Examples of such data are the public keys that are transmitted to the archive module.

Two-way Electronic White Board

A two-way electronic white board may be a very helpful tool for the VPN described herein. The electronic white board module 275 provides this functionality to the system. This two-way white board will allow all parties in a session to draw pictures for each other's benefit and have these pictures appear on all screens participating in the session. The user may draw directly on the computer screen, or, the user may use a pad (similar to a mouse pad) that will detect a device such as a pen. Other embodiments of this technology are also contemplated for use with the VPNs described herein. This pad will detect the information being drawn by the user and display this same information on each screen.

Many software techniques can be used to facilitate the use of electronic white board with the described invention. For example, in one embodiment, a white board will instantly appear on all session screens as soon as one person chooses to use the white board function. In another embodiment, multiple people can use the white board simultaneously. It may be advantageous for the white board to be easily hidden when it is no longer needed. Additionally, it may be advantageous for the white board to support various fonts, colors, graphics, line art, and other graphic techniques that will allow the participants to better understand the meaning of the graphics being created.

Electronic Note Pad

The consultation module 260 can have a number of additional functionalities to maximize the effectiveness of a consultation session. One such functionality is found in the electronic note pad module 280. Special hardware, software applications programs, or both can be configured to provide a highly capable and functional electronic notepad, which can be made available to the participants of a consultation session. Such notepads can be used to type, create graphics, copy from the electronic white board, record speech, record audio/video, capture chat-room style text, and other such means to capture information that is being transmitted during the session.

At the end of each session, the contents of the electronic notepad being used by the consultants may be archived with the archive module 270 along with the other session information as well.

Internal Communication Module

As discussed herein, it is possible to have consultation sessions between multiple parties. The Internal communication module 285 allows participants to communicate with one another in a private, secure manner. For example, in the case of an arbitration, it is advantageous for the counsel of one side to be able to communicate with her client without the other side listening in. The internal communication module provides the functionality necessary to achieve this purpose. Communications may be verbal, visual, text, or a combination of all the above. Similar hardware, software, or combinations of both that enable the consultation sessions can be exploited to provide the internal communications of this module.

Secretarial Module

Because clients will be exposed to excellent counsel by a potentially large pool of experts, it may be helpful to provide a secretarial service to these consultants/clients. The secretarial module 290 provides the platform with which to secure such services. In one embodiment, a user can communicate with either a private or public secretary through the secretarial module 290. The secretary can receive instructions and perform numerous tasks as per the user's requests. The secretarial service may have access to a database filled with information previously provided by the client. This way the secretary can perform tasks such as sending a dozen flowers to a spouse, sending birthday card to a sibling, etc.

Electronic Mail Module

It may be helpful to provide e-mail services to the participants of a consultation session. The electronic mail module 295 provides such functionality. This module possesses the hardware, software, or both to permit users of the system to send electronic mail to each other and to the outside world.

Language Translation

If a consultant is paired with a client who resides in a different country, it may be necessary to provide a language translation function. The language translation module 299 provides this functionality. This language translation function can be achieved using filters that receive speech or text and convert this information into another language in a quick and efficient manner. By using this language translation feature it will be possible to cross international borders to receive counsel and advice from qualified consultants. The VPN may need to translate the text or speech of the consultant only. The VPN may need to translate the text or speech of the client only. The VPN may need to translate and text or speech of both the consultant and the client.

Directory of Potential Participants for a Conferencing Expert Services Network

Clients will make constant requests for other people to join or establish a conferencing session. Since it is virtually impossible to manage people by their IP address, it is better to establish a directory service that is accessible over the Internet that takes a name, phone number, or ID as input and returns the appropriate IP address. Such a directory service will be available, preferably as a function of the archive module. Such directory services will typically be operated as a dynamically updated database within the consultation module 260. Although this service can also be a stand alone module.

Other Non-Consulting Applications

It is possible that the novel methods and systems described above may be used to limit the liability for applications that are not necessarily consulting applications. For example, a provider of a “Tax Calculator” software program that will calculate the amount of tax owed during a certain year may require the client to agree beforehand to waive his/her right to initiate legal action as long as negligence is not involved.

Display of Still Images

From time-to-time a consultant may be required to display one or more still photographic images. The consultation module 260 has the capability of displaying such information.

Encryption Key Escrow

An option for storing encryption keys is within an encryption key escrow. This encryption key escrow facility stores the encryption keys until either the keys are requested by a proper authority, or the statute of limitations has expired and the keys are destroyed. This encryption key escrow function is referred to as an “escrow” because the keys are stored by a neutral third party. This third party organization has no vested interest in either protecting the consultant/expert or the client. The escrow service simply stores the encryption keys in a database until such time as the keys are needed to resolve an issue relating to one or more archived video sessions. The encryption key escrow can also work for electronic documents.

Archive Escrow

The archived videos can also be placed in an escrow as well. The archive escrow will function the same way the encryption key escrow will function (as described above), however, the database will be filled with streaming video segments rather than encryption keys. A dual encryption key escrow and archive escrow can be established and maintained by the same entity. Therefore, these functions can easily be combined on a sufficiently large database. A dual encryption key escrow and archive escrow can be established and maintained as well.

Preference Settings

Each video conferencing application will have preference settings and custom software systems that are designed to resolve specific issues or problem related to the application. For example, a real estate broker using the system may wish to display certain video sequences again and again. A therapist may wish that the entire video be viewed only under a court order. Either way, there are preference settings and options that are unique to each application. Some of these preference setting or options are: capture and save all audio/video in the video archive; capture the video but do not save the audio/video in the video archive; do not capture any audio/video; pre-determine the length of the session (with an automatic logoff after the time period has expired); allow a virtually infinite length of time for the video conferencing session; bill the participants by the day, hour, minute, second, or fraction of a second; do not bill the participants directly; allow multiple participants; allow two participants only, and others. There are a virtually unlimited number of preference settings (or options) that can be determined for a specific application.

The operators and managers for such a VPN will be required to set various preferences for each application. These preferences can be binary switches that are either set “On” or “Off” by adjusting these binary switches. In some cases, the switches might allow options such as A., B., or C (rather than binary switches). Either way, various preferences can be established that will define how the application will be initiated, conducted, and how the video data will be maintained.

In some cases, these preference settings may initiate a software program (or applet) that might perform a specific function. An example of such a software program might be a two-way electronic white board. For example, when a math tutoring application is initiated, the two-way electronic white board software program is initiated for all participants of the session.

Each individual user may have individual preference settings (or options) as well. A user may have preference settings as follows: show all participants in a session on the screen at the same time; only show the participant who is currently talking to display; allow audio from all participants; allow audio from selected participants only; sound “on”; sound “off”; show still picture of user only (because user is not properly dressed); and other user level preference setting.

Multi-point Control Units (MCUs)

A Multi-point Control Unit (MCU) is a multiplexor that correctly manages the various streams of data in order that these signals will be properly distributed during a video conferencing session. The system described in this application will operate with a MCU or without an MCU. As long as each client participating in the video conferencing session has the capability to send and receive the proper signals, and the Video Archive Server has the capability to send and receive the proper signals without an MCU, then no MCU is required.

If an MCU is utilized, there are many methods of deploying such an MCU. For example, the MCU can be embedded within the Archive module; the MCU can be embedded within the Web module; one or more client devices can perform MCU functions; the MCU can be a separate network resource.

In the preferred embodiment for this application, no MCU unit is required. However, when an MCU is operational on such a network, then it is possible that the Archive module receives its data directly through the MCU. With a “One or more client devices” performing the MCU functions as indicated above in item 3, it is possible to achieve a peer-to-peer network such as the well known Napster (based in San Mateo, Calif.) or Gnutella peer-to-peer architecture thus greatly reducing the responsibilities of the Web Server.

There are a plurality of different ways that an MCU unit can be deployed in a VPN. For example, the MCU can establish the video conferencing session and archive the streaming video, thus acting as the archive module. Alternatively, the MCU can transfer the streaming video to the archive module. In another alternative, the streaming data can be transferred to a archive module using another server or client device other than the MCU.

The MCU can be a non-participant of the conferencing session. Alternatively, the MCU can be a participant of the conferencing session. An example of such an MCU configuration as a participant is that a user is operating the MCU unit as a client device.

There can be multiple MCU units that are operational during a video conferencing session. In such an example, only one MCU will direct the streaming video to a Video Archive Server (or act as the Video Archive Server) so there is no redundant archiving of video information.

Mbone Protocol

The MBONE (Multicast Backbone) permits internet multicasting. Where traditional IP traffic is defined as one sender to one receiver, multicasting has the ability of performing one sender to multiple receiver operations. Propagation can also be set to control how far traffic will go. Traffic can be restricted to a single host, site, region, or the whole world. The VPN as described herein can use Mbone as a multicast backbone protocol. The reason for using Mbone is to reduce the required bandwidth for multicasting.

An Exemplary Session

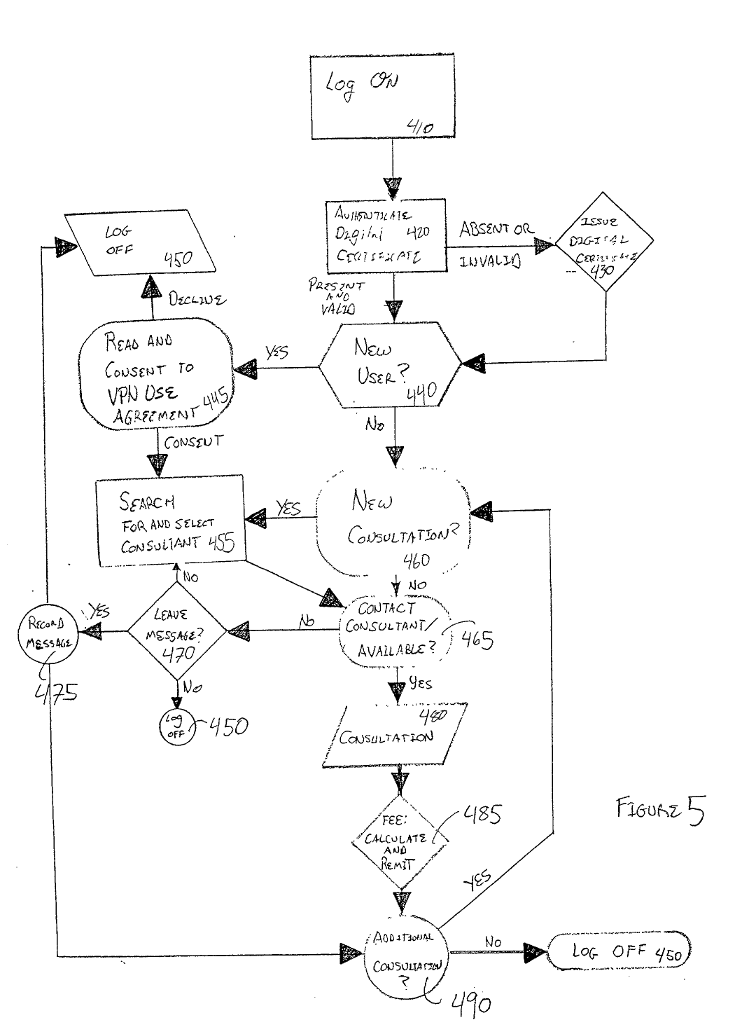

FIG. 5 outlines the steps a typical user will generally take when using the conferencing system of the described invention. A user will log on 410 to the system seeking a consultant for a particular problem. Once a connection is made to the consultation system, the system authenticates the digital certificate of the potential customer 420. If a digital certificate is absent or present but invalid, the user is shunted to a digital certificate issuing module 430. The issuing body may be the conferencing system itself or an third party.

If a digital certificate is present and valid, the system will next inquire whether or not the user is a new user or a repeat user 440. If the user is a new user, then the user is then directed to the liability limitation function of the system in which the VPN use agreement is presented for review and acceptance 445. If the user declines to consent to the agreement, the user is then automatically logged off the system 450. If the user consents to the agreement, then the user is sent to search for and select a consultant 455.

If the user is not a new user, the system will next inquire whether or not the user desires a new consultation 460. If a new consultation is sought, then the user is sent to search for and select a consultant 455.

Whether the user is seeking a new consultant or to contact a consultant with whom a relationship has already been formed, the system in this embodiment next inquires whether the selected consultant is available 465. If the desired consultant is not available, then the system, in this embodiment, will inquire whether or not the user would like to leave a message 470. If the user does not desire to leave a message, the user may search for and select a different consultant 455 or log off 450. If the user does desire to leave a message, the user is shunted to a message recording service to record a message 475. Once the message is left, the user can log off 450 or seek an additional consultation 490.

If the consultant is available, then a consultation 480 will begin according to the method described herein. Once the consultation is complete, the system will calculate the fee and the client will remit the fee 485.

Once the fee is paid and the system will prompt the user whether an additional consultation 490 is desired. If the user desires an additional consultation, then the user is prompted to indicate whether the additional consultation is a new consultation 460 and the process repeats. If no further consultations are desired, the user is prompted to log off.

### EXAMPLES

The methods and systems described herein provide the means with which to create a secure communications environment that is adapted for the exchange of sensitive information. One embodiment of the invention is uniquely adapted to limit the potential liability of an expert or consultant when practicing his or her art, science or profession over the Internet. A brief list of possible applications for the VPN described herein include, but are not limited to: therapy sessions, contract negotiations and executions, arbitration hearings, audits, business negotiations, physician consultations, attorney consultations, human resources functions, e.g., interviews, employee complaint hearings, scientific collaboration, governmental services, banking transactions, financial management transactions, correctional facility hearings and visitations, social services, and many others.

### Example 1

### Binding Arbitration Sessions

Another novel web application is binding or non-binding arbitration over the web using the disclosure in this application. Similar to the Consulting network disclosed above, an Arbitration VPN is configured in such a way as to allow all of the parties of an arbitration session to participate from remote locations. Each participant will be issued public and private keys (if they have not already been issued), digital certificates, and the video conference session will be appropriately encrypted and archived. Once again, after the arbitration session is complete, the CPS field of the digital certificate will be updated with a pointer to either a URL or a database that will contain the encrypted video conferencing session.

Although the Arbitration application is similar to the consulting application disclosed above, some special functions are required as follows:

There will need to be numerous motion picture boxes on the participant's screens. Each multi-media box will contain the streaming video image and the sound for one participant. Since two parties and an arbitrator are the minimum number of people required at an arbitration session, at least 3 multi-media boxes are required. There may be more multi-media boxes, however, if more people are invited to join the arbitration session (such as witnesses or attorneys).

The arbitrator or judge will need special tools in order to control the proceedings of the arbitration session. The arbitrator/judge will need special software tools that will enable the following functions: turn sound “off” one or more multi-media boxes; turn sound “on” one or more multi-media boxes; turn image “off” one or more multi-media boxes; turn image “on” one or more multi-media boxes; make a multi-media box larger on one or more screens; make a multi-media box smaller on one or more screens; open a new multi-media box and show an audio and/or video clip to one; or more participants and close an extra multi-media box; enable a telephone call to be placed for one or more participants; enable a telephone call to be terminated, as well as other functions.

The arbitrator or judge may need a set of tools as defined above and numerous other tools that are designed to allow the arbitrator/judge to control the session and ultimately attempt to achieve fairness and ultimately yield a common sense solution. The tools listed above can be used for other applications that require a judge or moderator as well.

### Example 2

### Internet Court Proceedings

Since it is possible to create an Arbitration application over the Internet including means for authentication, integrity, security, non-repudiation, and indemnification using digital certificate technology, it is also possible to conduct an entire courtroom session over the Internet. Granted that a viable courtroom session will be more in the area of small claims rather than Supreme Court, it is possible to generate key pairs for all participants along with the appropriate digital certificates. An archived copy of the streaming video conferencing session will be encrypted and archived with a pointer to the archived copy existing within the CPS filed of the digital certificate (as defined above). Using the methods and processes defined in this application, it is possible to administer actual courtroom proceedings using such a VPN.

### Example 3

### Business to Business Transactions

There are numerous applications where one business needs to provide valuable services directly to another business. In the future, it is expected that these business-to-business (B2B) applications will realize enormous growth. One such example is Human Resources (HR). One business may need the services of an HR consultant, however, using the novel technology defined in this application, it may not be necessary for the HR consultant to be physically present at the business site. It is possible to deploy the VPN as described above in such a way as to provide security, integrity, authenticity, nonrepudiation, and indemnification for uses in the B2B arena. In this context, nonrepudiation means that a participant in a business to should not be able to falsely deny later that he participated in a telecommunications session.

### Example 4

Second Opinions

Another valuable service that is offered through the VPN as described above is providing Second Opinions. For example, a patient may learn from his/her doctor that a radical treatment is prescribed for a particular malady. Before going ahead with the treatment, the patient may wish to get a second opinion. By using the novel methods described in this application, another doctor on the VPN can provide a second opinion in order for the patient to make an informed decision regarding the prognosis and the proposed treatment.

It is well known that certain health providers such as HMOs and PPOs may not be able to provide certain expensive treatments unless a second opinion is obtained. As soon as the licensed and qualified physician provides a second opinion and recommends an appropriate treatment, the HMO or PPO (or other such health consortium) may be forced to take the necessary steps to provide the treatment in question even if the treatment is expensive.

Patient files, X-rays, and other pertinent information can be transmitted securely between health care providers in order to render the best possible Second Opinions. Second Opinions can also be provided in numerous other disciplines other than medicine.

### Example 5

### Depositions

Enabling lawyers to perform long distance depositions over such a network as described above is an important technology for legal practices to deploy in the near future. Potential witnesses to events that are the focus of legal actions are sometimes out of the general geographical area where court proceedings are taking place. In some cases, a potential witness may even be out of the country. Using video conferencing technologies combined with security means, methods and processes to the limit potential liability, and, video archiving means as described above (to effectively depose witnesses) provides the basis for a potentially valuable application.

After such a deposition is complete, a transcript can be automatically generated. By using state-of-the-art voice recognition means and speech-to-text means, it is possible to automatically create a complete transcript of the deposition. (It is assumed, however, that a professional editor will need to review the video along with the text created by the speech-to-text generator in order to correct any errors that might have been created by the automation processes.

### Example 6

Electronically Entering Into an Agreement on the Web

For thousands of years people have been creating and signing written documents that authorize a transaction under a pre-defined set of terms and conditions. Such documents after being signed are usually filed away and indexed properly for easy access and retrieval in the future.

Today, such documents are scanned, stored, and indexed on mass storage devices connected to computer systems. As our world becomes networked, these types of written documents become harder to create, distribute, and archive. Moreover, a large percentage of the transactions that are authorized in the future may be between parties who are not physically located in the same place. Indeed, many transactions may be conceived, developed, reviewed, executed, and archived between people who are physically located in different parts of the world, or even in outer space. For these reasons, the example below outlines one method for entering into an agreement using electronic means.

In this example, all responsible parties use digital streaming camera technology along with digital microphone technology to enter into a video teleconferencing session. All parties also use digital certificate technology to authorize such a private session and verify that each participant is individually authorized to participate in the session. The digital certificate also serves to encrypt and secure the signals (SSL) from potential hackers as the session is in progress. Moreover, the digital certificate also serves to encrypt the streaming video information after the session is complete to protect the video contents from being viewed by an un-authorized persons.

Additionally, the digital certificate technology serves to decrypt the streaming video information at a later time using the public and/or private keys of the participants to both view and hear the session as well as prove the participant was not an imposter (because his/her Private key was used for the Encryption). Utilizing this decryption capability, participants can view the streaming video in order to see and hear the actual words and gestures of the parties to the agreement.

During the session all terms and conditions are carefully discussed, and debated. Outside experts may be called into the session using electronic means from time to time to add valuable insights and counsel to the session. When all of the terms and conditions to the agreement are approved by the responsible parties, then each participant will verbally and/or physically demonstrate his/her approval to the terms and conditions while being captured on a streaming audio/video device. The streaming video is then encrypted after the video capture function is performed for each session participant.

In this example, the audio/visual record of the transaction is encrypted for archiving by having each participant provide a session key and share that single session key among each session participant. Encrypting the record of the transaction provides that the streaming video information will be secure from potential hackers or unauthorized personnel. Moreover, the decryption process itself will prove that a participant of the session was in fact the person who entered into the agreement.

The video session or shared video session key required for decryption can only be decrypted using the public/private key(s) that were created (or issued) to the actual person in the session. This added advantage of using the private/private key(s) belonging to the actual participants to encrypt the session is designed to guard against a session participant claiming that an imposter was captured on video and not him/herself. Public/Private keys can be used in virtually any combination according to the requirements of the participants of the session and the requirements of the VPN.

The encrypted streaming video information is stored on a mass storage device or on the Internet in such a way as to be easily accessed and reviewed by any person who has the identical Public/Private key pairs used to encrypt the streaming video data. If Digital Certificate technology is used during these video conferencing sessions, the CPS field of each digital certificate can be modified to hold a pointer to a URL on the Internet that contains the encrypted streaming video of the agreement.

The participants of a conferencing session can allow third party participants to be added to the session or deleted from the session at virtually any time. If necessary, session keys will be transmitted to the new participants when they are added. If during a session a third or later party is dropped from the session, the remaining participants will have new session keys distributed to them to continue the secure conferencing session. The new session keys that are distributed to the remaining participants (after a participant leaves the conference) will also be transmitted to the video archive service so that subsequent conference transactions will be encrypted and archived appropriately.

The video archiving service may be participant of the video conferencing service whereby the video archive functions are being performed in a video conferencing gateway or video conferencing/multimedia multipoint control unit. The video archiving can also be performed by an independent video archiving service that is not a session participant but is fed with the multimedia feeds from all participants and the independent video archiving services sends archive status (but not video, audio, or multimedia feeds) to the other participants. In addition, the trusted authority can perform the video archiving.

This method for capturing an agreement can be used with the VPN that is being described in this application. Each client can be captured on streaming audio/video as they agree to all terms and conditions of the network. The streaming audio/video can be encrypted using the Public/Private keys that belong to the client and the CPS field of the Digital Certificate may be modified to hold a pointer to the location of such a “multi-media” agreement on the web.

The CPS field of the Digital Certificate may have the pointer to the URL for this client at the time the certificate is created and before any agreement information is loaded into this URL. As agreements are finalized between the client and the network, each agreement is encrypted and stored on the Internet in such a way as it can be accessed using the URL that was defined in the CPS field of the Digital Certificate at the time it was created.

This novel method for entering into an agreement using video conferencing technologies can also be extended to electronic documents that are “signed” on-line. Virtually all functions remain the same, however, instead of the video being stored/retrieved from the archive, the actual electronic document can be stored/retrieved from the archive as well.

Username and password information can also be entered by the user in order to have access to certain portions of the archive or to the “agreement system” itself. This username/password sequence may or may not be used in conjunction with the digital certificates that are issued.

### Example 7

Using Encryption Keys in a Video Conferencing Session

There are many ways to generate, distribute, and deploy Public/Private key technology. The example below describes one embodiment.

The client logs on (or connects) to the VPN for the first time. He or she will then be prompted to download a software program (possibly a software applet or servelet) on to the PC. This software program will from this point on be referred to as the Software Applet. It is preferred that this Software Applet will load itself automatically on the PC. This Software Applet will prompt the user through a routine that will create and store a Public/Private key pair to be used by the VPN as per the reasons described above.

If the user already has a Public/Private key pair stored on the PC, the user may simply indicate that a key pair already exists and use a “browse” function to point to the physical location on a storage medium where the key pair exists. It is also possible that the Software Applet will find a Public/Private key pair with no intervention from the user required.

Once the key pair exists, then a digital certificate is created by either the VPN or a trusted third party sometimes referred to as a Trusted Authority (TA), or a Certificate Authority (CA) or optionally a third party, or an archiving service. Once this digital certificate is created, it is loaded into the web browser program the client is currently using. (Examples of web browser software programs are: NETSCAPE NAVIGATOR and MICROSOFT INTERNET EXPLORER). The Software Applet will assist with this function of loading the digital certificate into the proper web browser database. All major web browser programs today recognize digital certificates and know where and how to store them.

This digital certificate that is now loaded into the browser's digital certificate data-base will allow the client on to the VPN, although no consulting session has yet begun. The Software Applet may also store the key pair in a physical location different than the browser. Potential physical locations include: a subdirectory on a disk drive, an area of battery-backed-up ram, a unused track or sector on a disk drive, and other places where digital certificate information can be stored.

At this point the Software Applet will log-on or link to an area of the VPN where the client will have the ability to agree to certain terms and conditions that are necessary to begin using the valuable applications on the VPN. Although there are many ways in which an agreement may be structured, a “live” person on the VPN can appear on the PC screen and begin to speak with the client, an artificially intelligent agent may speak with the client, or an automated audio or audio/visual computer script can be read by or played to the client.

The client will be asked to turn on a camera and microphone and agree to be a party to a video conferencing session for the purposes of entering into a binding agreement with the management organization for the VPN. Once this video conferencing session begins, the client will be provided with a fall list of terms, conditions, rules, regulations, and policies for using the VPN. The client will then be asked to verify that he/she understands and agrees to these various terms, conditions, rules, regulations, and policies for using the VPN. The verification process will performed by capturing the streaming video session of the client demonstrating that he/she understands the various conditions for using the VPN and he/she also agrees to all of the various conditions as well. These terms, conditions, rules, regulations, and policies may change depending upon the specific applications the client wishes to use.

Encryption of the session (using SSL or other) may begin when the client signs up for services or while browsing for a consultant or when an actual consulting session begins. This encryption of the session is designed to protect the client's identity while he/she is browsing for a consultant, enrolling for the service, and conducting a session with a consultant.

As soon as the client has agreed to all terms, conditions, rules, regulations, and policies, the video session is encrypted using the VPN's private key or a session key generated for this session and stored on a video archive provided by the VPN or video archive service. (This will allow only authorized party with the session key to view the agreement entered into between the client and the VPN.) Then, the client's digital certificate can optionally be updated with a pointer (in the CPS field of the certificate) to the location of the streaming video containing the agreement between the client and the VPN.

Pointers in the CPS field of the digital certificate include: a character string, a URL, an IP address, an LDAP function call, an ODBC function call, any other type of function or procedure call, or any other means to point to a multi-media file. The client's Public Encryption Key is transmitted to an entity called a Root CA (unless the Root CA generated the Public Key at which time the Root CA will already have the client's Public Key).

The Public Key for the Root CA will be transmitted to the client. This Root CA Public Key will either be stored in a database used to store the client's Public and Private key pair as described above, or, this Root CA Public Key can be stored in a separate location as defined by the Software Applet.

In sessions where a CA is being utilized for Public/Private key encryption keys the following events will occur to allow a client to access the valuable services on the VPN. The Root CA will transmitted the Root CA Public Key to the client and the client has transmitted his/her own Public Key to the Root CA, the user can now use the valuable services on the VPN.

The Root CA function can be an additional function that is performed by the Archive Server (as described above), or the Root CA may be an independent entity. The primary function of the Root CA is simply to transmit a Public Key to the client and receive a Public Key from the same client in order to secure the communications lines and lower the risk that a hacker may be able to “spy” on the communications lines.

From this point on, when any client wants to log on to the VPN, the encryption keys and the digital certificates will be used to create an SSL session in order to secure the communications between the client and the secure web site. It is commonly known that the SSL protocol will transmit a secret encoding method to all parties on the VPN. This encoding method will allow the signals to pass as quickly as possible while maintaining encrypted (scrambled) signals that are virtually impossible to decrypt. It is possible to use transmission protocols other than SSL.

After this agreement is entered into, archived, the client's digital certificate has been updated, and an SSL (or similar) session has begun the user may begin a consulting session. After selecting the desired consultant from a list of consultants who are currently on-line and available, the following events will occur: The VPN will verify that all digital certificates are in-place and there are no restrictions in effect for the client. The VPN will scan the list of all available consultants and evaluate all criteria for the client. For example, a client who is a resident of the state of California who wishes to consult with an attorney about a California real estate matter will need to speak with an attorney who is licensed to practice law in the state of California.

All consultants found to be available on the VPN who meet the minimum criteria requirements will be displayed for the client. Additionally, information regarding the consultant's background and experience will be made available to the client. A small advertisement that is paid for by the consultant may be displayed for the client as well. The client will then select a consultant using a mouse click or a series of key presses on the PC. The VPN will once again check the availability of the consultant and then notify the consultant that his services are being requested.

The VPN will allow the consultant the ability to begin the consulting session or the VPN will allow the consultant to decline the session. If the session is declined by the consultant, the client will be asked to re-select another consultant as described in item c. above.

As soon as the consultant agrees to participate in a new session, a new “Session Key” will be created by the VPN and the Software Applet running on the PC will load this new Session Key into the database of public/private keys on the PC. This “Session Key” will be used to secure the transmission signals (using SSL or similar protocol) as well as provide the necessary authentication, integrity checks, nonrepudiation, and encryption that are required for the session. The Session Key can be generated using the Public Keys that belong to the participants of the session.

The main purpose of a “Session Key” is to encrypt all of the video/multi-media feeds that will be archived received by the archiving service from multiple parties only one time. There will be only one copy of the video saved in the archive, however, there may be numerous parties to a video conferencing session. By creating a “Session Key” then only one copy of the video needs to be stored. Otherwise, a separate video would need to be stored for each participant and each participant would need to encrypt the participants video sent to all other participants with the unique public key of every participant, requiring multiple video feeds containing the same video information but uniquely encrypted for each participant. Another important aspect of this system is that the archive server does not need to be a participant of the videoconference, and does not need to be the certificate authority. In addition the archive module will be sending status information to each or selected conference participants. Status information such as “archiving” or “recording”, “archive failure with reason for error”, “archive identification for subsequent access to the video archive”, “participant added”, “participant removed with new encryption key distributed to remaining participants”, etc.

Both the client and the consultant will be prompted to label the session. Such a label is an identifier that will help the client easily identify the video conferencing session in the future. An example of such a label is as follows:

“My first video conferencing session with James Smith.”

This label can either be created using text characters typed in with a keyboard, and/or an audio clip that is spoken, and/or a video conferencing clip.

The video conferencing session takes place. The consultant can see and hear the client and the client can see and hear the consultant. If numerous parties are participating in this video conferencing session, then they will all be able to see and hear each other.

If only two people are participating in a video conferencing session, then the major portions of the video display for each participant will be filled with the streaming video image of the other party. If multiple people are participating in a video conferencing session, then individual boxes (rectangles) may appear on the screen and the streaming video images of the other participants will appear in these boxes. There is no reason for a participant to see his/her own image on the display screen. When the session is finished, the “Session Key” or archive log will be stored in an encrypted format using the public keys for each participant.

The archived video is then saved at the video archive facility until an appropriately authorized demand is issued for the release of the archived video and the necessary Keys (used to decrypt the video), or the Statute of Limitations is reached for all parties to the video conferencing session. The video is copied to CD-ROM or DVD in order to be shipped or mailed to the consultant.

Certain consultants such as doctors, therapists, and lawyers require an environment where their communication is kept private and confidential. Therefore, this archived video session will not be made available to any person or entity unless the Video Archive is properly notified that the archived video session is needed due to legal action of some type. The streaming video can be saved to the archive server using a filter on the H.323 and/or the sub-protocol layer. This filter takes the real-time streaming video, encrypts the video, and then copies it to the archive server.

### Example 8

### System for Public Terminal and Internet Access and Email

As electronic conferencing technologies and applications become ubiquitous, it will become important to allow access to such a VPN as described in this application in public facilities such as airports, restaurants, parking lots, parks, gymnasiums, and other such locations. A preferred embodiment with which to access to the VPN 30 of FIG. 1 is via a public terminal with Internet access as described below:

The Public Email Terminal (PET) will allow a user of the terminal secure access to email, voice mail, fax messages, pager messages, unified message servers, and company networks via a publicly located terminal that is readily accessible in the same manner as a public or hotel payphone. The Public Email Terminal will be easy to use and will automatically configure itself to operate and communicate like the user's office computer when accessing email, voice mail, fax, video, video conferencing, pager and computer connections. The ease of use will be a result of incorporating multiple user interfaces that are automatically configured within the PET, so that the PET user does not need to learn any new software to use the terminal.

Because sensitive private data may be transferred via the Internet or other non-secure transmission links, data can be encrypted within the Public Email Terminal, the Telecommunications Carrier or NAP, and the corporate message servers that the PET accesses.

The PET is easy to use, and is automatically configured with network routing and addressing information, passwords, and user preferences for each user of the terminal. Because ease of use is important, the PET will be configured from a credit-card called like device called the User Access Card (UAC). The UAC will contain a user ID and a Personal Identification Number (PIN). The actual network configuration address and data can be read from the users access card, or the address and data can be read from the card in an encrypted format with subsequent decryption performed by the NAP server, or by the companies message access server.

The PET will allow a user to access different computer based message systems, and will offer the user the convenience of a public personal computer. In addition the PET can offer multiple user interfaces with the terminal so that the user does not need to learn any new software.

The Public Email Terminal is a public standalone computer terminal, similar to a public payphone which allows secure access to many different computer based services and unified message mailboxes via a direct dialup connection or a computer network connection or a combination of both.

The PET is also a public computer terminal with optional pay telephone that allows the user an easy to use terminal for accessing any type of computer based data and messaging. The PET can also operate as a public personal computer and run either network computer type ‘thin clients’ or full IBM PC type applications.

One element of the PET is the use of a number of encryption techniques to provide secure access to computer networks, email, fax, voice mail, and other message services via the Internet or other public networks. In one embodiment of the PET public/private key encryption will be used with two required public keys. The public key for the NAP login server will be required, and a second public key would be for the user's company wide message server. This two key architecture would allow the NAP to offer encrypted login access to the NAP's access network and access to the users company wide message servers (not the NAP servers). The NAP server and the company wide message server would have their own encrypted login and access for access and/or message data.

When the PET has a private connection or a known private dialup or leased line connection to the network access point encryption from the PET to the NAP server will not be required. However, the data contained on the users access card will be encrypted to eliminate the possibility of reading the settings from a lost card.

Because there is not a single remote access encryption standard, the PET will support many different modes of encryption, offering the encryption standard compatible with the encryption a company or firm may use for their corporate networks. The PET or NAP server that supports multiple encryption standards will offer the corporation using the PET system for remote access from public locations the encryption required by the corporation. In a preferred embodiment of the PET, the PET or NAP Server will support the following encryption and/or authentication: password based, encoded ID cards, biometrics devices, dynamic tokens from software or hardware based token cards, and digital certificates.

The PET will be easy to use because the network connection parameters will automatically be configured when the user accesses the network from a NAP. The network access parameters (IP addresses for servers, etc.) can be read from the user access card. Or, the user network settings can be read from the NAP server and not the user access card. In this situation the user access card will contain the users id and the NAP server will return the network configuration data from a secure database within the NAP server. After the user ID and PIN are entered the PET will automatically be configured with the correct type of security, appropriate user interfaces and message access agents for the messages the user is interested in accessing.

In addition, the PET can act as a client to the NAP server and use the NAP server as a network connection host for the PET. In this fashion the NAP server will configure network access resources within the NAP server to provide the PET network connections via the NAP server. The system will operate in a client (PET), network access server NAP manner when implemented in this manner, where the PET is a simple client and all network access and configuration occur via the NAP server.

An example of how the PET would be used is presented below: The user swipes their personal access user access card (calling or credit type card) through a card accepting device. The PET prompts the user for a Personal Identification Number similar to an automatic teller PIN. The user enters the PIN. The PET encrypts the user ID, PIN and optionally the terminal ID and sends the encrypted information to a NAP server.

The NAP server decrypts the user ID, PIN and if included the terminal ID and determines if this is an authorized user. If the information is from an authorized user the NAP server encrypts the network settings and preferences for the user and sends them back to the terminal in an encrypted format.

The PET decrypts the settings and configures the PETs network and dialup connections, user interfaces, and server access methods (protocols, etc.) required for this user session. Steps 3, 4, and 5 above are automatically executed after the user performed steps 1 and 2 above.

At this point the user is configured to run applications with software they already know how to use. The user can check their email, fax, voice mail, video mail, pager, unified mailbox messages and other computer based messages with the press of a single button. The example will continue with a description of accessing email messages from a PET, but the example applies for any type of dialup or network based message access. In addition the PET user can access the companies corporate network at this time.

The user presses the check email prompt on the PET. In addition the PET when configured can automatically read the message mail box statuses after step 5 when the network connection is configured.

The PET will encrypt the login account name and password for the users email account, and send the encrypted login request to the corporate email server for the user. If public key encryption is used the PET will encrypt the login message with the public key of the email server. When private key encryption is used, the private key for the user and email server will be used by the PET for secure email access.

The PET's email message agent software can access message status from a number of different email message servers running different access protocols. The access will be encrypted to provide secure message transmissions over the computer network when the connections use a computer network for communications.

The user can view the message status (4 new messages for example), read a new message, reply to a messages, forward a message, and save or delete a message. The PET will allow the user to perform any message manipulation function that a normal computer based messaging application provides.

When the user has completed their email message tasks, the PET will allow the user to access other message from other message servers, or it can offer free or pay per usage web browser and Internet access for other Internet services (FTP, Gopher, email, etc.). In situations where the NAP desires to offer free Internet access the NAP can insert advertisements to help pay for the costs associated with the PET.

When the user has completed their session they can press the end session button, or hang up the phone (if they were using the telephone) to erase all session data. An optional printer built into the PET can allow the user to print data during the session.

When the PET terminal is being used, additional network based data gathering processing can occur to automatically download stock portfolio information or other web based data. The automatically collected data can be displayed on the PET's display for the user to view. The PET and/or NAP server can simultaneously access multiple message servers to speed up the message access. In addition, the user of the PET terminal can talk on the payphone while the PET accesses message servers.

A preferred embodiment of the PET includes the following features:

The card reader is similar to a credit card-like device for reading input to identify the user. Data contained on the credit card can be encrypted with private or public encryption techniques. The credit card device can be a optical, mechanical, or magnetic.

A card reader for magnetic stripe cards, smart cards, or secure network smartcards (such as Security Dynamics Secure Token Cards) for terminal access. Data contained on the card will identify the user to the computer Network Access Provider (NAP) and can contain network address settings, user preferences, and other user or network specific data. In the future when biometrics parameters (fingerprints, eye patterns, voice patterns, face recognition, etc.) are used to verify a user, these future methods can be incorporated into the PET.

A Personal Identification Number (PIN) number similar to the PIN used with banking automatic teller machines (ATM). The PIN will be required when using the swipe card or smart card to use the PET. In the situation where the users credit card is lost the NAP can count the number of failed login attempts and disable the account. In addition, the computer access service provider can notify the user of a high number of failed login attempts.

Any method of secure communications including public and private key encryption, certificate based security, with a terminal ID and its optional public key to provide a secure, non-reputable ID for the PET. The PET may include a direct connection to the NAP and in this situation encryption can be performed at the central site for the NAP and not at the PET. If the PET's is connected locally to a network than the PET will include encryption and decryption within the PET. Secure communications can optionally incorporate the secure socket layers (SSL) web and Internet access.

Automatic configuration of network settings for the user when the user access the PET. When the user accesses a PET their required network and/or TCP/IP address settings would be automatically configured for email servers (POP, SMTP, other), DNS servers, PBX access servers, unified message servers and access, and other computer message and access servers. In addition, the settings for dialup access to non-computer network based services would be automatically configured for non-network based PBX and voice mail systems, and other non-network accessible message servers. The automatic configuration of network settings can also support mobile roaming Internet access techniques such as the proposed IPASS protocol. The network settings can be decrypted by the NAP or by a central server controlled by the company for which the user works. In either case, the network settings for the PET user would be encrypted by either the NAP or the companies message server to provide added security and privacy.

A keyboard, telephone keypad, and pointing device to allow user input similar to current day computers. Voice recognition and other computer input methods could be used for terminal input. A video display (LCD, plasma, CRT or other) is incorporated to the PET.

An optional payphone type telephone handset and keyboard interface, a coin slot, and card reader for standard payphone operation. The PET can optionally allow simultaneous computer network and voice operation. This would allow the user to begin their computer message download while using the telephone call.

Computer network access capability to access the Internet or other computer network. Computer network access can be via any network communications technique including: dialup telephone line, a leased line, direct LAN connection, telephone or digital modem, ISDN, ADSL (or other type DSL type service), cable modem, satellite, RF modem, T1, ATM, frame relay, or any other type of computer network access hardware and/or methods.

Multiple media (voice, fax, email, video, pager, etc.) access agents for accessing any type of computer based messages or data. Multiple media access agents can be located within the PET or the PET can act as a client to a server housed by the NAP. When the PET acts as a client to the network access providers server the multiple media access agents can be centrally housed by the NAP and the cost associated with multiple media access agents can be distributed.

Multiple server access agents will allow access to different servers via the Internet or direct dialup connections for sending and retrieving messages. For example, access to a voice mail system can be via the Internet or a dialup connection. The multiple server access agents provided by the NAP will be able to accommodate the access needs to almost every popular message servers. The multiple server access agents will work with unified message systems and will provide multiple media access to the unified mailboxes. The capability to display/play, forward, delete, edit, archive and reply to any form of message can be incorporated into the PET.

Multiple message accounts on multiple servers even on multiple different networks will be accessible with the PET. The user can access three email accounts on two or three different servers each using a different access protocol.

Remote secure access to corporate computer network directories (email, fax, voice mail, pager, etc.) would be accessible by the PET user when they use the terminal.

Automatic erasure of all session parameters and data when the user hangs up or presses an End Session key. A message will be sent to the NAP servers to flush all user data and end the session. Billing data for the session can be computed and added to the users account.

Optional capability to run office suites such as Lotus Notes, Microsoft Office, Excel, Word, scheduling, directory access, Word-Perfect and other popular computer applications.

The NAP can provide value added services such as; encryption public key directories access, access to certificate authorities, and other cryptographic services to provide a secure public terminal with secure data transmission. This will allow the NAP's to offer value-added services similar to the Telephone Company's 4-1-1-information directory for telephone numbers.

The option to select which message access services the user wants. For example, if the user was in a hurry they may only want to access their voice mail or email, but not their fax or video messages. In addition, when the PET is being used for normal telephone operation a summary of the electronic messages that exist for this user could be displayed on the PETs display.

What is claimed is:

1. A method for providing a secure communication network to provide consultations between a client and a consultant comprising:
providing to the client via said secure communication network at least one web module;
providing to the client a liability limitation module through the at least one web module, wherein a liability limiting agreement is provided to the client by the liability limitation module;
receiving a message from the client via said communication network indicating consent to said agreement;
providing to the client via said communication network a list of consultants from a consultant database module;
receiving a message from the client via said communication network indicating a choice of consultants;
receiving a message from the choice of consultants consenting to see the client;
providing to the client and the choice of consultants a secure consultation environment within which a conference occurs.

2. The method of claim 1, further comprising issuing a digital certificate to the client after the client has logged on to the communication network.

3. The method of claim 1, further comprising providing the client an opportunity to leave a message for the choice of consultants.

4. The method of claim 1, further comprising calculating a fee based on service rendered within the secure consultation environment.

5. The method of claim 1, further comprising providing an archival copy of the conference recorded by the archive module.

6. The method of claim 1, wherein the at least one web page is accessed by a web-enabled device selected from the group consisting of an individual computer, a mobile computer, a personal digital assistant, a hand-held computer, a web-enabled television, a web-enabled interactive kiosks, a web-enabled wireless communications device, a mobile web browsers, or a combination thereof.

7. A system for providing a secure communication network to facilitate consultations between a client and a consultant comprising:
at least one web module configured to provide at least one web page;
a certificate module configured to provide a digital certificate to the client once said client contacts the at least one web module;
a liability limitation module configured to provide a liability limiting agreement to the client via the at least one web module;
a payment module configured to calculate a fee for services rendered to the client via the at least one web module;
a consultant database module configured to provide a list of consultants to the client, from which the client selects a consultant of choice via the at least one web module; and
a consultation module configured to provide a secure communication environment within which the consultant of choice and the client confer via the at least one web module.

8. The system of claim 7, wherein said certificate module issues a digital certificate to the client after the client has logged on to the secure communication network.

9. The system of claim 7, further comprising a source module configured to supply code to support the consultation module.

10. The system of claim 7, further comprising an archive module configured to archive the conference between the client and the consultant.

11. The system of claim 7, further comprising an electronic white board module configured to provide communication between the client and the consultant.

12. The system of claim 7, further comprising an electronic note module configured to provide notes between the client and the consultant.

13. The system of claim 7, further comprising an internal communication module configured to provide internal communications between parties.

14. The system of claim 7, further comprising a secretarial module configured to provide secretarial services.

15. The system of claim 7, further comprising an electronic mail module configured to provide electronic mail services.

16. The system of claim 7, further comprising a language translation module configured to provide language translation services.

17. The system of claim 7, wherein the at least one web page is accessed by a web-enabled device selected from the group consisting of an individual computer, a mobile computer, a personal digital assistant, a hand-held computer, a web-enabled television, a web-enabled interactive kiosks, a web-enabled wireless communications device, a mobile web browsers, or a combination thereof.
